(19) United States
(12) Patent Application Publication
(10) Pub. No.: US 2026/0094068 A1
(43) Pub. Date: Apr. 2, 2026

(54) System, Method, and Computer Program Product For Deep Learning With Plausible Deniability

(71) Applicant: Visa International Service Association, San Francisco, CA (US)

(72) Inventors: Wenxuan Bao, Gainesville, FL (US); Hadi Abdullah, Carrollton, TX (US); Shan Jin, Georgetown, TX (US); Anderson Clayton Alves Nascimento, University Place, WA (US); Yiwei Cai, Mercer Island, WA (US)

(21) Appl. No.: 19/341,334

(22) Filed: Sep. 26, 2025

Related U.S. Application Data
(60) Provisional application No. 63/700,147, filed on Sep. 27, 2024.

(51) Int. Cl. G06N 20/00; G06Q 20/40

(52) U.S. Cl. CPC G06N 20/00; G06Q 20/4016

(57) ABSTRACT

Systems, methods, and computer program products are provided for deep learning with plausible deniability. An example system includes at least one processor configured to: (i) obtain a dataset including a plurality of batches of data samples; (ii) compute a plurality of gradients of the plurality of batches; (iii) select a gradient; (iv) add noise to the selected gradient; (v) determine, based on the noised gradient and the plurality of gradients, a number of gradients that satisfy a privacy function; (vi) in response to the number of gradients that satisfy the privacy function satisfying a threshold number, training, using the noised gradient, a machine learning model; and (vii) in response to the number of gradients that satisfy the privacy function failing to satisfy the threshold number, reshuffling the dataset to generate an updated plurality of batches of data samples and returning to step (ii).

### CROSS-REFERENCE TO RELATED APPLICATION

This application claims priority to U.S. Provisional Patent Application No. 63/700,147, filed Sep. 27, 2024, the entire disclosure of which is hereby incorporated by reference in its entirety.

### BACKGROUND

### 1. Technical Field

This disclosure relates generally to defense mechanisms for deep learning models and, in some non-limiting embodiments or aspects, to systems, methods, and computer program products for deep learning with plausible deniability.

### 2. Technical Considerations

Deep learning models have been successful in many applications, but they are still vulnerable to attacks and can compromise user privacy. Although some defense mechanisms, such as Differential Privacy (DP), offer protection with theoretical guarantees, they typically reduce the model's performance. On the other hand, empirical defense methods may maintain better performance, but they lack robust theoretical guarantees.

### SUMMARY

Accordingly, provided are improved systems, methods, and computer program products for deep learning with plausible deniability. Non-limiting embodiments or aspects of the present disclosure may provide training systems, methods, and computer program products, which may be referred to as Plausibly Deniable Stochastic Gradient Descent (PD-SGD), that provide stronger privacy protection with theoretical justification and maintain higher performance. Non-limiting embodiments or aspects of PD-SGD may employ a rejection sampling technique, which probabilistically prevents or inhibits updating model parameters whenever a mini-batch cannot be plausibly denied, which may ensure that no individual example has a disproportionate influence on the model parameters, thereby, effectively mitigating privacy leakage from individual data points and offering a favorable trade-off between privacy and utility compared to existing defense methods.

According to some non-limiting embodiments or aspects, provided is a system, including: at least one processor configured to: (i) obtain a dataset including a plurality of batches of data samples; (ii) compute a plurality of gradients of the plurality of batches of data samples; (iii) select a gradient of the plurality of gradients; (iv) add noise to the selected gradient to generate a noised gradient; (v) determine, based on the noised gradient and the plurality of gradients, a number of gradients of the plurality of gradients that satisfy a privacy function; (vi) in response to the number of gradients of the plurality of gradients that satisfy the privacy function satisfying a threshold number, training, using the noised gradient, a machine learning model; and (vii) in response to the number of gradients of the plurality of gradients that satisfy the privacy function failing to satisfy the threshold number, reshuffling the dataset to generate an updated plurality of batches of data samples and returning to step (ii).

In some non-limiting embodiments or aspects, the noise added to the selected gradient to generate the noised gradient includes isotropic Gaussian noise.

In some non-limiting embodiments or aspects, the privacy function is defined according to the following Equation:

$${α}^{- 1} \leq \frac{p ( {\tilde{g}}_{s} - {g}_{s} )}{p ( {\tilde{g}}_{s} - {g}_{i} )} \leq α$$

where α=exp(γ) for some γ>0, p(·) denotes the density of the isotropic Gaussian noise [symbol] (0, Iσ²), gₛ is the selected gradient, \tilde{g}ₛ is the noised gradient, and gᵢ is a gradient of the plurality of gradients.

In some non-limiting embodiments or aspects, the privacy function is defined according to the following Equation:

$$\vert ln p ( z ) - ln p ( {\tilde{g}}_{s} - {g}_{i} ) \vert \leq γ$$

where γ>0, p(·) denotes the density of the noise z, \tilde{g}ₛ is the noised gradient, and gᵢ is a gradient of the plurality of gradients.

In some non-limiting embodiments or aspects, the gradient of the plurality of gradients is randomly selected.

In some non-limiting embodiments or aspects, the data samples are associated with transactions in an electronic payment processing network, wherein the at least one processor is further configured to: provide the trained machine learning model; receive transaction data associated with a transaction currently being processed in an electronic payment processing network; process, using the trained machine learning model, the transaction data to generate a prediction associated with the transaction; and authorize or deny, based on the prediction, the transaction in the electronic payment processing network.

In some non-limiting embodiments or aspects, the prediction includes a classification of the transaction as a fraudulent transaction or a non-fraudulent transaction.

According to some non-limiting embodiments or aspects, provided is a method, including: (i) obtaining, with at least one processor, a dataset including a plurality of batches of data samples; (ii) computing, with the at least one processor, a plurality of gradients of the plurality of batches of data samples; (iii) selecting, with the at least one processor, a gradient of the plurality of gradients; (iv) adding, with the at least one processor, noise to the selected gradient to generate a noised gradient; (v) determining, with the at least one processor, based on the noised gradient and the plurality of gradients, a number of gradients of the plurality of gradients that satisfy a privacy function; (vi) in response to the number of gradients of the plurality of gradients that satisfy the privacy function satisfying a threshold number, training, with the at least one processor, using the noised gradient, a machine learning model; and (vii) in response to the number of gradients of the plurality of gradients that satisfy the privacy function failing to satisfy the threshold number, reshuffling, with the at least one processor, the dataset to generate an updated plurality of batches of data samples and returning to step (ii).

In some non-limiting embodiments or aspects, the noise added to the selected gradient to generate the noised gradient includes isotropic Gaussian noise.

In some non-limiting embodiments or aspects, the privacy function is defined according to the following Equation:

$${α}^{- 1} \leq \frac{p ( {\tilde{g}}_{s} - {g}_{s} )}{p ( {\tilde{g}}_{s} - {g}_{i} )} \leq α$$

where α=exp(γ) for some γ>0, p(·) denotes the density of the isotropic Gaussian noise [symbol] (0, Iσ²), gₛ is the selected gradient, \tilde{g}ₛ is the noised gradient, and gᵢ is a gradient of the plurality of gradients.

In some non-limiting embodiments or aspects, the privacy function is defined according to the following Equation:

$$\vert ln p ( z ) - ln p ( {\tilde{g}}_{s} - {g}_{i} ) \vert \leq γ$$

where γ>0, p(·) denotes the density of the noise z, \tilde{g}ₛ is the noised gradient, and gᵢ is a gradient of the plurality of gradients.

In some non-limiting embodiments or aspects, the gradient of the plurality of gradients is randomly selected.

In some non-limiting embodiments or aspects, the data samples are associated with transactions in an electronic payment processing network, wherein the method further includes: providing, with the at least one processor, the trained machine learning model; receiving, with the at least one processor transaction data associated with a transaction currently being processed in an electronic payment processing network; processing, with the at least one processor, using the trained machine learning model, the transaction data to generate a prediction associated with the transaction; and authorizing or denying, with the at least one processor, based on the prediction, the transaction in the electronic payment processing network.

In some non-limiting embodiments or aspects, the prediction includes a classification of the transaction as a fraudulent transaction or a non-fraudulent transaction.

According to some non-limiting embodiments or aspects, provided is a computer program product including at least one non-transitory computer-readable medium including program instructions that, when executed by at least one processor, cause the at least one processor to: (i) obtain a dataset including a plurality of batches of data samples; (ii) compute a plurality of gradients of the plurality of batches of data samples; (iii) select a gradient of the plurality of gradients; (iv) add noise to the selected gradient to generate a noised gradient; (v) determine, based on the noised gradient and the plurality of gradients, a number of gradients of the plurality of gradients that satisfy a privacy function; (vi) in response to the number of gradients of the plurality of gradients that satisfy the privacy function satisfying a threshold number, training, using the noised gradient, a machine learning model; and (vii) in response to the number of gradients of the plurality of gradients that satisfy the privacy function failing to satisfy the threshold number, reshuffling the dataset to generate an updated plurality of batches of data samples and returning to step (ii).

In some non-limiting embodiments or aspects, the noise added to the selected gradient to generate the noised gradient includes isotropic Gaussian noise.

In some non-limiting embodiments or aspects, the privacy function is defined according to the following Equation:

$${α}^{- 1} \leq \frac{p ( {\tilde{g}}_{s} - {g}_{s} )}{p ( {\tilde{g}}_{s} - {g}_{i} )} \leq α$$

where α=exp(γ) for some γ>0, p(·) denotes the density of the isotropic Gaussian noise [symbol] (0, Iσ²), gₛ is the selected gradient, \tilde{g}ₛ is the noised gradient, and gᵢ is a gradient of the plurality of gradients.

In some non-limiting embodiments or aspects, the privacy function is defined according to the following Equation:

$$\vert ln p ( z ) - ln p ( {\tilde{g}}_{s} - {g}_{i} ) \vert \leq γ$$

where γ>0, p(·) denotes the density of the noise z, \tilde{g}ₛ is the noised gradient, and gᵢ is a gradient of the plurality of gradients.

In some non-limiting embodiments or aspects, the gradient of the plurality of gradients is randomly selected.

In some non-limiting embodiments or aspects, the data samples are associated with transactions in an electronic payment processing network, wherein the at least one processor is further configured to: provide the trained machine learning model; receive transaction data associated with a transaction currently being processed in an electronic payment processing network; process, using the trained machine learning model, the transaction data to generate a prediction associated with the transaction; and authorize or deny, based on the prediction, the transaction in the electronic payment processing network, and wherein the prediction includes a classification of the transaction as a fraudulent transaction or a non-fraudulent transaction.

Further non-limiting embodiments or aspects are set forth in the following numbered clauses:

Clause 1: A system, comprising: at least one processor configured to: (i) obtain a dataset including a plurality of batches of data samples; (ii) compute a plurality of gradients of the plurality of batches of data samples; (iii) select a gradient of the plurality of gradients; (iv) add noise to the selected gradient to generate a noised gradient; (v) determine, based on the noised gradient and the plurality of gradients, a number of gradients of the plurality of gradients that satisfy a privacy function; (vi) in response to the number of gradients of the plurality of gradients that satisfy the privacy function satisfying a threshold number, train, using the noised gradient, a machine learning model; and (vii) in response to the number of gradients of the plurality of gradients that satisfy the privacy function failing to satisfy the threshold number, reshuffle the dataset to generate an updated plurality of batches of data samples and returning to step (ii).

Clause 2: The system of clause 1, wherein the noise added to the selected gradient to generate the noised gradient includes an isotropic Gaussian noise.

Clause 3: The system of clause 1 or 2, wherein the privacy function is defined according to the following Equation:

$${α}^{- 1} \leq \frac{p ( {\tilde{g}}_{s} - {g}_{s} )}{p ( {\tilde{g}}_{s} - {g}_{i} )} \leq α$$

where α=exp(γ) for some γ>0, p(·) denotes the density of the isotropic Gaussian noise [symbol] (0, Iσ²), gₛ is the selected gradient, \tilde{g}ₛ is the noised gradient, and gᵢ is a gradient of the plurality of gradients.

Clause 4: The system of any of clauses 1-3, wherein the privacy function is defined according to the following Equation:

$$\vert ln p ( z ) - ln p ( {\tilde{g}}_{s} - {g}_{i} ) \vert \leq γ$$

where γ>0, p(·) denotes the density of the noise z, \tilde{g}ₛ is the noised gradient, and gᵢ is a gradient of the plurality of gradients.

Clause 5: The system of any of clauses 1-4, wherein the gradient of the plurality of gradients is randomly selected.

Clause 6: The system of any of clauses 1-5, wherein the data samples are associated with transactions in an electronic payment processing network, and wherein the at least one processor is further configured to: provide the trained machine learning model; receive transaction data associated with the transaction currently being processed in the electronic payment processing network; process, using the trained machine learning model, the transaction data to generate a prediction associated with the transaction; and authorize or deny, based on the prediction, the transaction in the electronic payment processing network.

Clause 7: The system of any of clauses 1-6, wherein the prediction includes a classification of the transaction as a fraudulent transaction or a non-fraudulent transaction.

Clause 8: A method, comprising: (i) obtaining, with at least one processor, a dataset including a plurality of batches of data samples; (ii) computing, with the at least one processor, a plurality of gradients of the plurality of batches of data samples; (iii) selecting, with the at least one processor, a gradient of the plurality of gradients; (iv) adding, with the at least one processor, noise to the selected gradient to generate a noised gradient; (v) determining, with the at least one processor, based on the noised gradient and the plurality of gradients, a number of gradients of the plurality of gradients that satisfy a privacy function; (vi) in response to the number of gradients of the plurality of gradients that satisfy the privacy function satisfying a threshold number, training, with the at least one processor, using the noised gradient, a machine learning model; and (vii) in response to the number of gradients of the plurality of gradients that satisfy the privacy function failing to satisfy the threshold number, reshuffling, with the at least one processor, the dataset to generate an updated plurality of batches of data samples and returning to step (ii).

Clause 9: The method of clause 8, wherein the noise added to the selected gradient to generate the noised gradient includes an isotropic Gaussian noise.

Clause 10: The method of clause 8 or 9, wherein the privacy function is defined according to the following Equation:

$${α}^{- 1} \leq \frac{p ( {\tilde{g}}_{s} - {g}_{s} )}{p ( {\tilde{g}}_{s} - {g}_{i} )} \leq α$$

where α=exp(γ) for some γ>0, p(·) denotes the density of the isotropic Gaussian noise [symbol] (0, Iσ²), gₛ is the selected gradient, \tilde{g}ₛ is the noised gradient, and gᵢ is a gradient of the plurality of gradients.

Clause 11: The method of any of clauses 8-10, wherein the privacy function is defined according to the following Equation:

$$\vert ln p ( z ) - ln p ( {\tilde{g}}_{s} - {g}_{i} ) \vert \leq γ$$

where γ>0, p(·) denotes the density of the noise z, \tilde{g}ₛ is the noised gradient, and gᵢ is a gradient of the plurality of gradients.

Clause 12: The method of any of clauses 8-11, wherein the gradient of the plurality of gradients is randomly selected.

Clause 13: The method of any of clauses 8-12, wherein the data samples are associated with transactions in an electronic payment processing network, and wherein the method further comprises: providing, with the at least one processor, the trained machine learning model; receiving, with the at least one processor transaction data associated with the transaction currently being processed in the electronic payment processing network; processing, with the at least one processor, using the trained machine learning model, the transaction data to generate a prediction associated with the transaction; and authorizing or denying, with the at least one processor, based on the prediction, the transaction in the electronic payment processing network.

Clause 14: The method of any of clauses 8-13, wherein the prediction includes a classification of the transaction as a fraudulent transaction or a non-fraudulent transaction.

Clause 15: A computer program product, comprising: at least one non-transitory computer-readable medium including program instructions that, when executed by at least one processor, cause the at least one processor to: (i) obtain a dataset including a plurality of batches of data samples; (ii) compute a plurality of gradients of the plurality of batches of data samples; (iii) select a gradient of the plurality of gradients; (iv) add noise to the selected gradient to generate a noised gradient; (v) determine, based on the noised gradient and the plurality of gradients, a number of gradients of the plurality of gradients that satisfy a privacy function; (vi) in response to the number of gradients of the plurality of gradients that satisfy the privacy function satisfying a threshold number, train, using the noised gradient, a machine learning model; and (vii) in response to the number of gradients of the plurality of gradients that satisfy the privacy function failing to satisfy the threshold number, reshuffle the dataset to generate an updated plurality of batches of data samples and returning to step (ii).

Clause 16: The computer program product of clause 15, wherein the noise added to the selected gradient to generate the noised gradient includes an isotropic Gaussian noise.

Clause 17: The computer program product of clause 15 or 16, wherein the privacy function is defined according to the following Equation:

$${α}^{- 1} \leq \frac{p ( {\tilde{g}}_{s} - {g}_{s} )}{p ( {\tilde{g}}_{s} - {g}_{i} )} \leq α$$

where α=exp(γ) for some γ>0, p(·) denotes the density of the isotropic Gaussian noise [symbol] (0, Iσ²), gₛ is the selected gradient, \tilde{g}ₛ is the noised gradient, and gᵢ is a gradient of the plurality of gradients.

Clause 18: The computer program product of any of clauses 15-17, wherein the privacy function is defined according to the following Equation:

$$\vert ln p ( z ) - ln p ( {\tilde{g}}_{s} - {g}_{i} ) \vert \leq γ$$

where γ>0, p(·) denotes the density of the noise z, \tilde{g}ₛ is the noised gradient, and gᵢ is a gradient of the plurality of gradients.

Clause 19: The computer program product of any of clauses 15-18, wherein the gradient of the plurality of gradients is randomly selected.

Clause 20: The computer program product of any of clauses 15-19, wherein the data samples are associated with transactions in an electronic payment processing network, and wherein the at least one processor is further configured to: provide the trained machine learning model; receive transaction data associated with the transaction currently being processed in the electronic payment processing network; process, using the trained machine learning model, the transaction data to generate a prediction associated with the transaction; and authorize or deny, based on the prediction, the transaction in the electronic payment processing network, and wherein the prediction includes a classification of the transaction as a fraudulent transaction or a non-fraudulent transaction.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

Additional advantages and details are explained in greater detail below with reference to the non-limiting, exemplary embodiments that are illustrated in the accompanying schematic figures, in which:

FIG. 1 is a schematic diagram of an electronic payment processing network, according to some non-limiting embodiments or aspects;

FIG. 2 is a schematic diagram of example components of one or more devices of FIG. 1, according to some non-limiting embodiments or aspects;

FIG. 3A is a flow diagram of a method for deep learning with plausible deniability, according to some non-limiting embodiments or aspects;

FIG. 3B is a flow chart for a method for using a machine learning model trained using a method for deep learning with plausible deniability, according to some non-limiting embodiments or aspects;

FIG. 4 is graph of a privacy-utility tradeoff of various training methods;

FIG. 5 is diagram of passing versus failing gradients of an example privacy test;

FIG. 6 depicts pseudo-code for a method for deep learning with plausible deniability, according to some non-limiting embodiments or aspects;

FIG. 7 is a table including results of evaluations of non-limiting embodiments or aspects of Plausibly Deniable Stochastic Gradient Descent (PD-SGD) and other defense mechanisms on various datasets using various different attacks;

FIG. 8 is a table including results of evaluations of non-limiting embodiments or aspects of PD-SGD and other defense mechanisms on a ResNet-like model;

FIG. 9 is a table including results of evaluations of a privacy test and noise on non-limiting embodiments or aspects of PD-SGD;

FIG. 10 is a table including hyperparameters used for the evaluations of FIGS. 7 and 8;

FIG. 11 is a table of example reference symbols; and

FIG. 12 is a table of computational time measurements results.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects of the disclosed subject matter. Hence, specific dimensions and other physical characteristics related to the embodiments or aspects disclosed herein are not to be considered as limiting.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may, also, be a desktop computer or other form of non-mobile computer.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.”

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

Non-limiting embodiments or aspects of the present disclosure provide systems, methods, and/or computer program products that (i) obtain a dataset including a plurality of batches of data samples; (ii) compute a plurality of gradients of the plurality of batches of data samples; (iii) select a gradient of the plurality of gradients; (iv) add noise to the selected gradient to generate a noised gradient; (v) determine, based on the noised gradient and the plurality of gradients, a number of gradients of the plurality of gradients that satisfy a privacy function; (vi) in response to the number of gradients of the plurality of gradients that satisfy the privacy function satisfying a threshold number, training, using the noised gradient, a machine learning model; and (vii) in response to the number of gradients of the plurality of gradients that satisfy the privacy function failing to satisfy the threshold number, reshuffling the dataset to generate an updated plurality of batches of data samples and returning to step (ii).

In this way, some non-limiting embodiments or aspects of the present disclosure may leverage the concept of plausible deniability to enhance privacy protection in deep learning model training at the level of batches. For example, some non-limiting embodiments or aspects of the present disclosure may implement a privacy test at the level of gradient updates due to a mini-batch. If a mini-batch includes one or more data points that lead to an anomalous gradient (with respect to other mini-batch's gradients), the gradient may be rejected. In this way, any privacy leakage that would be due to data points with disproportionate influence (and, thus, possibly on model parameters) may be mitigated, thereby improving and ensuring the security of the model while reducing training time and memory requirements. Accordingly, some non-limiting embodiments or aspects of the present disclosure may offer a better trade-off between privacy and utility compared to existing defense mechanisms, such as Differential Privacy (DP) and empirical defense methods.

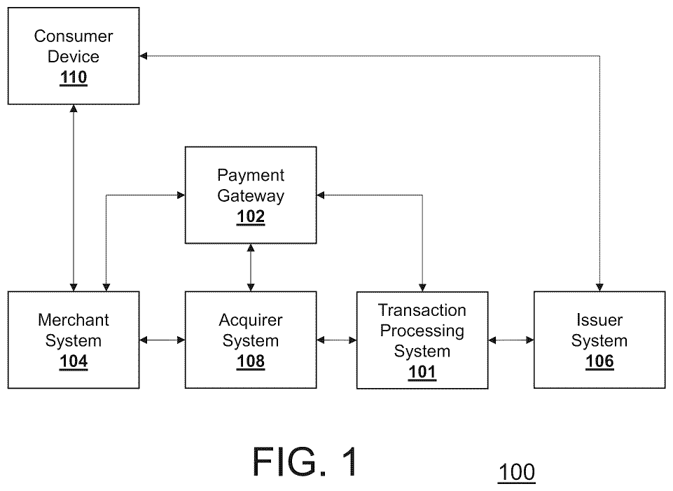

Referring now to FIG. 1, FIG. 1 shows electronic payment processing network 100, according to some non-limiting embodiments or aspects. Electronic payment processing network 100 may be used in conjunction with the systems and methods described herein. It will be appreciated that the particular arrangement of electronic payment processing network 100 shown is for example purposes only, and that various arrangements are possible. Transaction processing system 101 (e.g., a transaction handler) is shown to be in communication with one or more issuer systems (e.g., such as issuer system 106) and one or more acquirer systems (e.g., such as acquirer system 108). Although only single issuer system 106 and single acquirer system 108 are shown, it will be appreciated that transaction processing system 101 may be in communication with a plurality of issuer systems and/or acquirer systems. In some non-limiting embodiments or aspects, transaction processing system 101 may, also, operate as an issuer system, such that both transaction processing system 101 and issuer system 106 are a single system and/or controlled by a single entity.

In some non-limiting embodiments or aspects, transaction processing system 101 may communicate with merchant system 104 directly through a public or private network connection. Additionally or alternatively, transaction processing system 101 may communicate with merchant system 104 through payment gateway 102 and/or acquirer system 108. In some non-limiting embodiments or aspects, acquirer system 108 associated with merchant system 104 may operate as payment gateway 102 to facilitate the communication of transaction requests from merchant system 104 to transaction processing system 101. Merchant system 104 may communicate with payment gateway 102 through a public or private network connection. For example, merchant system 104, that includes a physical POS device, may communicate with payment gateway 102 through a public or private network to conduct card-present transactions. As another example, merchant system 104, that includes a server (e.g., a web server), may communicate with payment gateway 102 through a public or private network, such as a public Internet connection, to conduct card-not-present transactions.

In some non-limiting embodiments or aspects, transaction processing system 101, after receiving a transaction request from merchant system 104 that identifies an account identifier of a payor (e.g., such as an account holder) associated with consumer device 110, may generate an authorization request message to be communicated to issuer system 106 that issued consumer device 110 and/or account identifier. Issuer system 106 may then approve or decline the authorization request and, based on the approval or denial, generate an authorization response message that is communicated to transaction processing system 101. Transaction processing system 101 may communicate an approval or denial to merchant system 104. When issuer system 106 approves the authorization request message, it may then clear and settle the payment transaction between issuer system 106 and acquirer system 108.

The number and arrangement of systems and devices shown in FIG. 1 are provided as an example. There may be additional systems and/or devices, fewer systems and/or devices, different systems and/or devices, and/or differently arranged systems and/or devices than those shown in FIG. 1. Furthermore, two or more systems or devices shown in FIG. 1 may be implemented within a single system or device, or a single system or device shown in FIG. 1 may be implemented as multiple, distributed systems or devices. Additionally or alternatively, a set of systems (e.g., one or more systems) or a set of devices (e.g., one or more devices) of electronic payment processing network 100 may perform one or more functions described as being performed by another set of systems or another set of devices of electronic payment processing network 100.

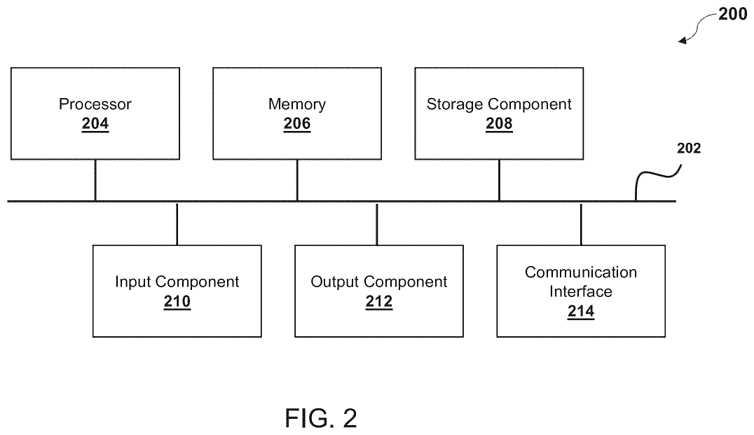

Referring now to FIG. 2, shown is a diagram of example components of device 200, according to some non-limiting embodiments or aspects. Device 200 may correspond to transaction processing system 101, payment gateway 102, merchant system 104, issuer system 106, acquirer system 108, and/or consumer device 110, as an example. In some non-limiting embodiments or aspects, such systems or devices may include at least one device 200 and/or at least one component of device 200. The number and arrangement of components shown are provided as an example. In some non-limiting embodiments or aspects, device 200 may include additional components, fewer components, different components, or differently arranged components than those shown. Additionally or alternatively, a set of components (e.g., one or more components) of device 200 may perform one or more functions described as being performed by another set of components of device 200.

As shown in FIG. 2, device 200 may include bus 202, processor 204, memory 206, storage component 208, input component 210, output component 212, and communication interface 214. Bus 202 may include a component that permits communication among the components of device 200. In some non-limiting embodiments or aspects, processor 204 may be implemented in hardware, firmware, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read only memory (ROM), and/or another type of dynamic or static storage device (e.g., flash memory, magnetic memory, optical memory, etc.) that stores information and/or instructions for use by processor 204.

With continued reference to FIG. 2, storage component 208 may store information and/or software related to the operation and use of device 200. For example, storage component 208 may include a hard disk (e.g., a magnetic disk, an optical disk, a magneto-optic disk, a solid-state disk, etc.) and/or another type of computer-readable medium. Input component 210 may include a component that permits device 200 to receive information, such as via user input (e.g., a touch screen display, a keyboard, a keypad, a mouse, a button, a switch, a microphone, etc.). Additionally or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.). Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium may include any non-transitory memory device. A memory device includes memory space located inside of a single physical storage device or memory space spread across multiple physical storage devices. Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally or alternatively, hardwired circuitry may be used in place of or in combination with software instructions to perform one or more processes described herein. Thus, embodiments described herein are not limited to any specific combination of hardware circuitry and software. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

Deep learning models have become integral components of many contemporary technological applications, ranging from image and speech recognition to natural language processing. The ability of deep learning models to uncover complex patterns in data and provide high predictive accuracy has driven broad acceptance and deployment across multiple industries. However, the pervasive usage of deep learning raises significant security and privacy issues. Privacy attacks, such as membership inference attacks, have been shown to exploit vulnerabilities, compromising the confidentiality of the training data used to train the model.

Protecting privacy while maintaining model performance is a major challenge. Existing defense strategies are such that practitioners must choose between strong privacy guarantees and high model utility. Existing approaches, based on DP offer strong mathematical privacy guarantees. When applied to machine learning, these existing approaches typically include clipping and adding large amounts of noise to the gradients during training, but this technique often results in drastic degradation of model performance. On the other hand, empirical defense strategies, such as Adversarial Regularization and SELENA, often preserve performance but come without mathematical justification that privacy is protected and, thus, may ultimately prove to be highly vulnerable to future (e.g., yet-to-be-discovered, etc.) attacks.

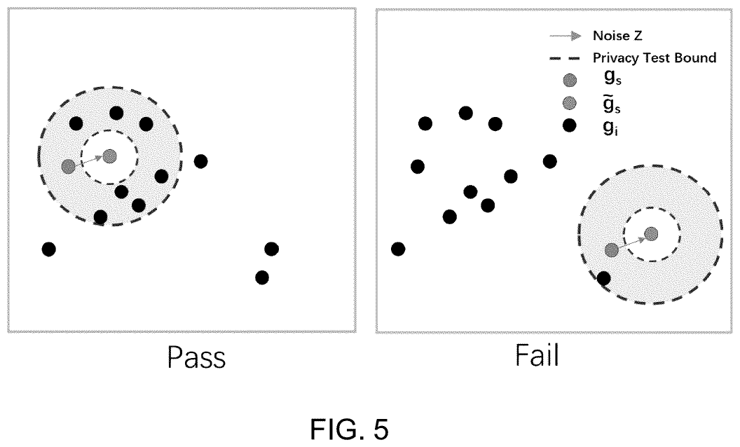

Non-limiting embodiments or aspects of the present disclosure provide training to systems, methods, and computer program products, which may be referred to as Plausibly Deniable Stochastic Gradient Descent (PD-SGD), that ensure that a model trainer can plausibly deny a claim that a given batch of data was used to train the model by pointing to other batches that are similarly likely to have been used. This approach provides batch-level privacy (and by implication privacy for individual examples in the batch) because it implies that whatever can be learned from a batch could instead have been learned from other batches. The non-limiting embodiments or aspects of PD-SGD may leverage an efficient privacy test, which inspects potential gradients from mini-batches before the potential gradients are used to update model parameters. This privacy test enforces that anomalous gradients (e.g., gradients that are not plausibly deniable, etc.) are discarded, thereby eliminating the leakage that may otherwise result from such updates as illustrated in FIG. 5.

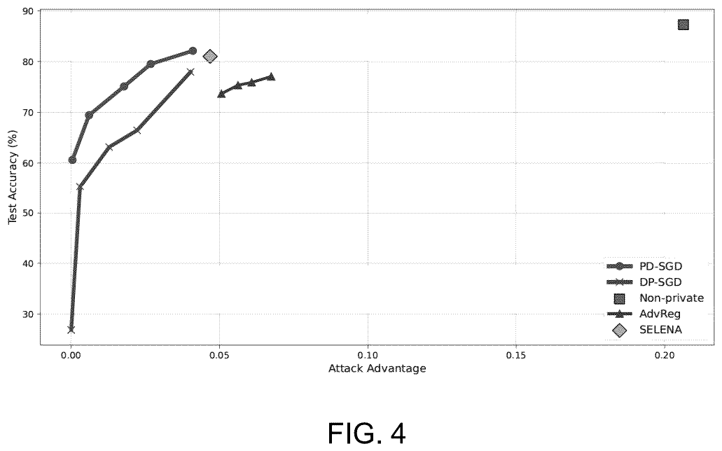

Theoretical foundations of non-limiting embodiments or aspects of PD-SGD are first discussed herein, including the design and the privacy offered by non-limiting embodiments or aspects of PD-SGD. Non-limiting embodiments or aspects of PD-SGD are, also, evaluated experimentally herein, comparing performance and trade-offs of non-limiting embodiments or aspects of PD-SGD with those of existing methods, such as Differentially Private Stochastic Gradient Descent (DP-SGD) and empirical defenses. Results demonstrate that non-limiting embodiments or aspects of PD-SGD offer a favorable privacy-utility trade-off compared to alternatives as illustrated in FIG. 4.

Plausible deniability is a fundamentally different paradigm to private learning than differential privacy. For example, non-limiting embodiments or aspects of PD-SGD enable to plausible deny the usage of a batch at a specific training iteration, but approaches based on DP, such as PD-SGD do not. DP-SGD enables to plausibly deny the presence of a specific example at a specific training iteration, but not an entire batch. Nevertheless, under certain conditions, plausible deniability yields (ε, δ)-DP guarantees.

There are, also, noteworthy differences between non-limiting embodiments or aspects of PD-SGD and DP-SGD: non-limiting embodiments or aspects of PD-SGD may not require computing per-example gradients, and (unlike DP-SGD) non-limiting embodiments or aspects of PD-SGD may support non-decomposable loss functions. This is because non-limiting embodiments or aspects of PD-SGD may operate at the batch level, whereas DP-SGD operates at the per-example gradient level.

Consider a supervised model represented by a function ƒ_{θ} where θ denotes the weights/trainable parameters of the model. The model may be trained using a dataset D of n data points (xᵢ, yᵢ), i∈[1, n] and solving for a vector θ that minimizes a loss function [symbol] (·) on D. This is typically done using Stochastic Gradient Descent (SGD) or a variant thereof. Non-limiting examples herein focus on mini-batch SGD, which may be referred to herein as “vanilla” SGD. In each iteration, the algorithm partitions the training set into equal-sized (e.g., roughly equal sized, substantially equal sized, within a threshold percentage of size, such as plus-or-minus 1%, etc.) mini-batches, randomly picks a mini-batch, and updates the parameters/weights of the model according to the mini-batch's gradient. For example, given a mini batch Bⱼ, let gⱼ=∇_{θ} [symbol] (θ, Bⱼ)∈ [symbol] ^{k} denote the gradient of the loss on Bⱼ with respect to the model parameters θ∈ [symbol] ^{k}. The update at step t is therefore: θₜ=θₜ₋₁−ηgⱼ, where η is the chosen learning rate.

Membership inference attacks (MIAs) have been extensively studied in recent years. MIAs are privacy attacks in which an adversary aims to determine if a target example (x, y) was included in a training dataset of a model. For example, the adversary may seek to discern between two competing hypotheses: H₀ (“non-member” or “out”): (x, y)∉D, or H₁ (“member” or “in”): (x, y)∈D.

Membership inference attacks were first introduced by employing shadow models trained on data similar to the training data of the target to emulate the behavior of the target and generate attack data. Existing works propose different attack variants aimed at reducing adversarial uncertainty to improve attack effectiveness. One existing method proposes a Likelihood Ratio Attack (LiRA) and advocates for increasing true positive rates at low false positive rates.

Some defenses provide a formal privacy guarantee. This is the case for the widely-used technique DP-SGD, which provably satisfies differential privacy.

DP-SGD updates the model parameters iteratively like SGD, except that DP-SGD bounds privacy leakage through (1) per-example clipping and (2) noise addition. Each mini-batch gradient is computed as the average over the batch's per-example gradients, but the per-example gradients are first clipped to have bounded l₂-norm. This ensures that each example has a bounded influence on the mini-batch gradient that decreases with the size of the mini-batch. Further, the mini-batch gradient is noised with isotropic Gaussian noise before being used to update the parameters.

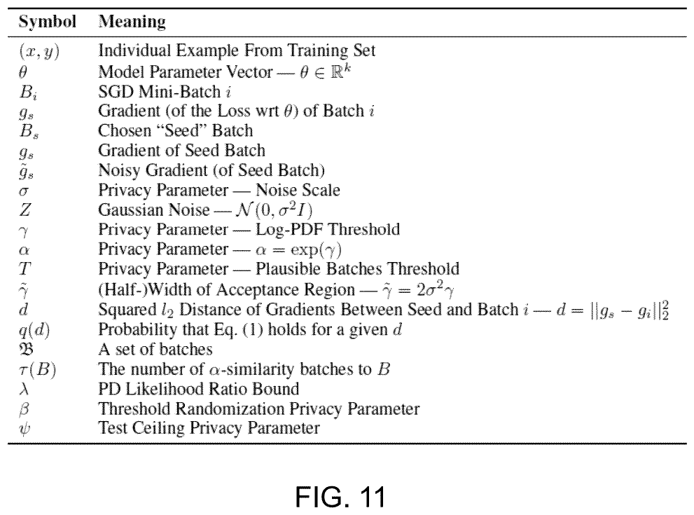

Referring to FIG. 11, which is a table of example reference symbols referred to herein, given a clipping threshold C>0, the noisy gradient may be defined according to

$${\overline{g}}_{j} = \frac{1}{L} {\sum }_{i} {g}_{j , i} \cdot min ( 1 , \frac{c}{‖ {g}_{j , i} ‖} ) + 𝒩 ( 0 , {σ}^{2} {C}^{2} I ) ,$$

where L is the number of examples in the mini-batch, g_{j,i} is the gradient vector of example i in batch Bⱼ, and σ is the noise level.

Models trained using DP-SGD may achieve (ε, δ)-differential privacy, where ε>0 is the privacy budget. However, a prediction accuracy of the models may suffer significantly due to the impact of the noise and gradient clipping. Careful tuning of hyperparameters, and/or use of techniques, such as data augmentation, may be used to obtain the favorable utility, for example, when the amount of training (or fine-tuning) data is limited. Another drawback of DP-SGD is increased training time and larger memory requirements, although recent research attempts to mitigate these issues.

To address the problem of low utility, while still effectively thwarting membership inference, several empirical defense mechanisms have been proposed. These include Adversarial Regularization (AdvReg) and SELENA, which are well-known and widely used as baselines. These defense mechanisms are applied at training time like DP-SGD.

These existing empirical approaches typically employ strategies, such as regularization, to lower the attack score or apply knowledge distillation to mitigate attacks. While these existing empirical defense mechanisms may preserve the model utility and offer some level of privacy protection, they lack provable theoretical guarantees. Consequently, it is unclear to what extent they truly eliminate sensitive information leakage or the degree to which they are effective against future attacks, especially adaptive attacks.

No existing defense mechanism simultaneously offers a theoretically justified guarantee and maintains good model utility. Non-limiting embodiments or aspects of PD-SGD are designed to help bridge this gap.

It is often said that differential privacy provides plausible deniability. DP ensures that the probabilities of any output on neighboring datasets (e.g., datasets that differ in exactly one example, etc.) are tightly bounded in terms of the privacy budget ε. Thus, in a sense, one can plausibly deny the membership of the differing example.

There are various existing attempts at formalizing plausible deniability notions for machine learning. One such existing method points out that since the same supervised model can be obtained from multiple datasets (including purely random ones), then one can deny the dataset used. Another existing method focuses on the problem of synthesizing tabular microdata where a synthetic row is produced from a single row of a database as a “seed,” and proposes that a synthetic row is plausibly deniable if the original database contains more than T (integer parameter) alternative rows that could have led to generating the synthetic with similar probability.

Non-limiting embodiments or aspects of the present disclosure provide a new formulation of plausible deniability that can be applied to SGD training at the level of mini-batches. To enforce plausible deniability, non-limiting embodiments or aspects may implement a privacy test on potential gradient updates from a mini-batch. If a mini-batch includes one or more examples that yield an implausible gradient (e.g., with respect to other mini-batch's gradients, etc.), that gradient is rejected and is not used to update the model parameters.

In an implementation of SGD in which a batch B is selected and its gradient vector g is computed, the counterfactual of having selected a batch B′=B∪{(x, y)} that includes some example (x, y) can be considered. A problem for privacy is that the gradient vector g′ for B′ may be completely different than g, even if the batch B is large. For example, g′ may point in the opposite direction, such that g′=−g, or g′⊥g, or even g′=0. If g′ is observed by an adversary (directly or indirectly) and can only be attributed to the presence of (x, y), privacy is compromised.

DP-SGD avoids this problem by using per-example gradient clipping. In contrast, instead of trying to restrict the change in the gradient that results from adding/removing any example, non-limiting embodiments or aspects of PD-SGD seek to detect those batches with gradients that are not plausibly deniable. Such batches may be thought of as “anomalous” compared to other batches, and any potential parameter updates based on them may be discarded.

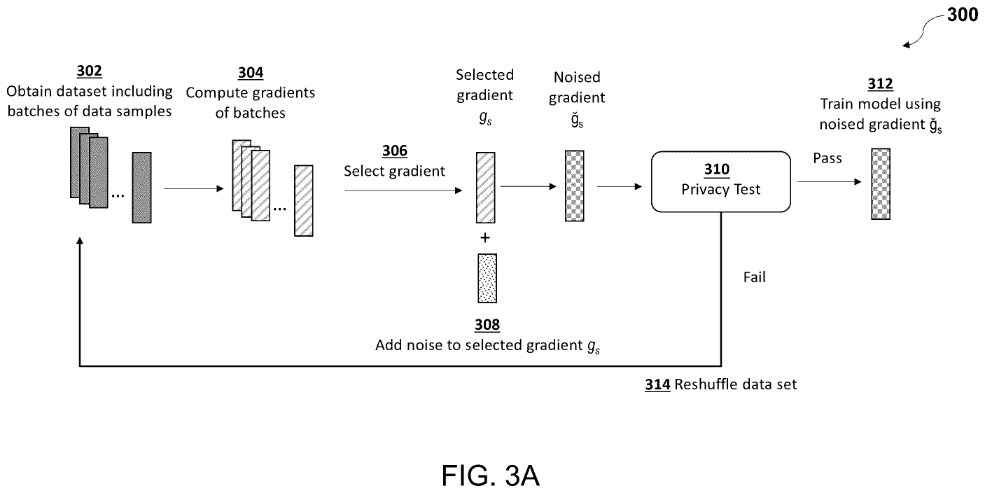

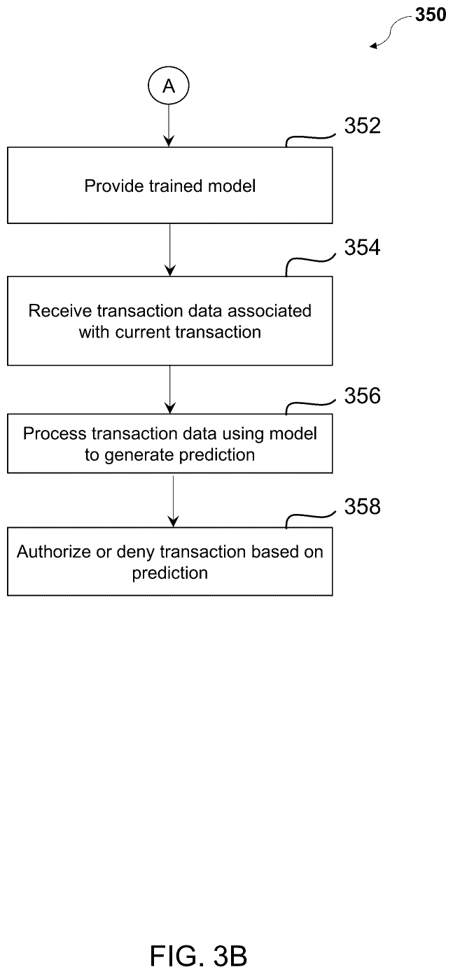

Referring now to FIG. 3A, shown is a flow diagram for method 300 for deep learning with plausible deniability, according to some non-limiting embodiments or aspects. The steps shown in FIG. 3A are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step.

As shown in FIG. 3A, at step 302, method 300 includes obtaining a dataset including a plurality of batches of data samples. For example, transaction processing system 101 may obtain a dataset including a plurality of batches of data samples. As an example, transaction processing system 101 may obtain a dataset D of n data points (xᵢ>yᵢ), i∈[1, n] that is partitioned into batches B, B₁, . . . , Bₘ. In some non-limiting embodiments or aspects, the data samples or data points may be associated with transactions between entities in electronic payment processing network 100.

As shown in FIG. 3A, at step 304, method 300 includes computing a plurality of gradients of the plurality of batches of data samples. For example, transaction processing system 101 may compute a plurality of gradients of the plurality of batches of data samples. As an example, transaction processing system 101 may compute a gradient gᵢ of each batch Bᵢ of the plurality of batches B, B₁, . . . , Bₘ.

As shown in FIG. 3A, at step 306, method 300 includes selecting a gradient of the plurality of gradients. For example, transaction processing system 101 may select a gradient of the plurality of gradients. The gradient of the plurality of gradients may be randomly selected. For example, transaction processing system 101 may randomly select a gradient vector gₛ of the loss with respect to the model parameters under seed batch Bₛ.

As shown in FIG. 3A, at step 308, method 300 includes adding noise to the selected gradient to generate a noised gradient. For example, transaction processing system 101 may add noise to the selected gradient to generate a noised gradient. The noise added to the selected gradient to generate the noised gradient may include an isotropic Gaussian noise. For example, transaction processing system 101 may add isotropic Gaussian noise with scale σ on the noise to the selected gradient vector gₛ to obtain a noisy gradient \tilde{g}ₛ. As an example, isotropic Gaussian noise may be added to a gradient vector g as \tilde{g}=g+Z, where Z˜ [symbol] (0, σ²I). Adding noise to the gradient in SGD has benefits for convergence and, in this case, may enable each (noisy) mini-batch gradient \tilde{g} as a random variable.

As shown in FIG. 3A, at step 310, method 300 includes determining, based on the noised gradient and the plurality of gradients, a number of gradients of the plurality of gradients that satisfy a privacy test function. For example, transaction processing system 101 may determine, based on the noised gradient and the plurality of gradients, a number of gradients of the plurality of gradients that satisfy a privacy test function.

Non-limiting embodiments or aspects of the present disclosure provide a modification to SGD in which the model parameters may be updated only if the gradient gᵢ is plausibly deniable, for example, if the gradient gᵢ is not too dissimilar to the gradients of some other mini-batches. The probability that a given fixed noised gradient vector \tilde{g} is plausibly obtained from any mini-batch gradient gᵢ can be defined, and from there the concept of a plausibly deniable gradient update can be defined.

Let B₁, . . . , Bₘ be disjoint mini-batches and g₁, . . . , gₘ be their associated gradient. Let Bₛ be the selected “seed” batch with associated gradient gₛ. Batch Bₛ may be said to be (α, σ, T) plausibly deniable if there are at least T>1 distinct batches Bᵢ with i∈[1, m] that satisfy the following Equation (1):

$${α}^{- 1} \leq \frac{p ( {\tilde{g}}_{s} - {g}_{s} )}{p ( {\tilde{g}}_{s} - {g}_{i} )} \leq α \qquad ( 1 )$$

where \tilde{g}ₛ=gₛ+Z for Z˜ [symbol] (0, σ²I). Here, α>0, α≥1, T>1 are privacy parameters.

Let α=exp(γ) for some γ>0 and p(·) denote the probability density function (pdf) of [symbol] (0, Iσ²). In some implementations, γ may be considered as the privacy parameter (instead of a). Taking the log of pdf, it can be seen that Equation (1) is equivalent to testing if satisfying the following Equation (2):

$$\vert log pdf ( Z ) - log pdf ( {\tilde{g}}_{s} - {g}_{i} ) \vert \leq γ \qquad ( 2 )$$

which is testable for the gradients gᵢ for each batch for i=1, 2, . . . , m because the log-pdf of isotropic Gaussian can be computed efficiently. Accordingly, the privacy function may be defined according to Equation (1) and/or (2).

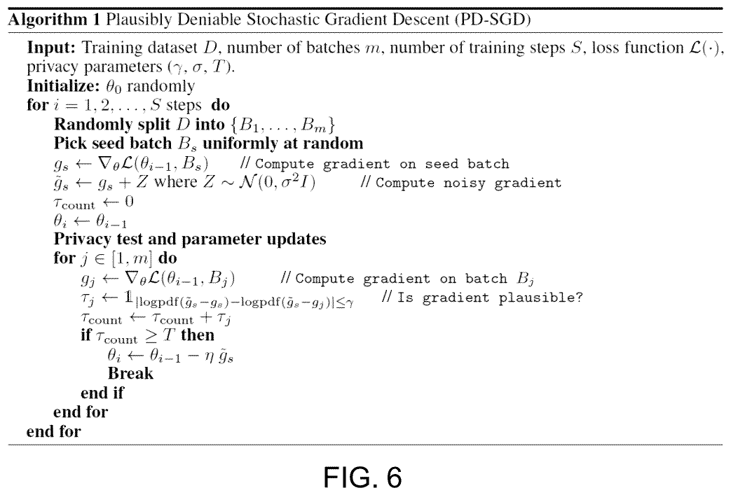

For example, and referring also to FIG. 6, which depicts pseudo-code for a method for deep learning with plausible deniability, according to some non-limiting embodiments or aspects, model parameter vector θ₀ may be initialized randomly and iterated for up to S learning steps. In each step, the training data D may be randomly partitioned into m roughly equal size batches B₁, . . . , Bₘ. However, unlike SGD, only a single seed batch Bₛ is selected among the batches B₁, . . . , Bₘ uniformly at random. The gradient vector of the loss with respect to the model parameters under seed batch Bₛ is computed, which results in gₛ, and isotropic Gaussian noise with scale σ on the noise is added to obtain noisy gradient \tilde{g}ₛ. Evaluating the privacy test involves the computation of the gradients of the other, non-selected batches and counting a number of unique batches that satisfy Equation (2).

As shown in FIG. 3A, at step 312, method 300 includes responding to the number of gradients of the plurality of gradients that satisfy the privacy function satisfying a threshold number, training, using the noised gradient, a machine learning model. For example, in response to the number of gradients of the plurality of gradients that satisfy the privacy test function satisfying a threshold number, transaction processing system 101 may train using the noised gradient, a machine learning model.

For example, and referring again to FIG. 6, the counted number of unique batches that satisfy Equation (2) may be compared to the threshold T. If the counted quantity is greater than or equal to the threshold T, the model parameters θᵢ may be updated with the noisy gradient \tilde{g}ₛ (and the inner loop of the pseudo-code of FIG. 6 is exited early).

As shown in FIG. 3A, at step 314, method 300 includes responding to the number of gradients of the plurality of gradients that satisfy the privacy test function failing to satisfy the threshold number, reshuffling the dataset to generate an updated plurality of batches of data samples and returning to step 302 of method 300. For example, in response to the number of gradients of the plurality of gradients that satisfy the privacy test function failing to satisfy the threshold number, transaction processing system 101 may reshuffle the dataset to generate an updated plurality of batches of data samples and return processing to step 302 of method 300.

For example, and referring again to FIG. 6, the counted number of unique batches that satisfy Equation (2) may be compared to the threshold T. If the counted quantity is less than the threshold T, the update to the model parameters θᵢ is never applied (keep θᵢ=θᵢ₋₁) (e.g., the update is discarded) and processing continues to the next step of the pseudo-code of FIG. 6.

Rejections of the privacy test may drive the privacy (and utility) of the model. For example, if the test never rejects any candidate gradient updates, a result may be equivalent to “vanilla” SGD. Informally, utility may be expected to be maximized when the rejection rate is near 0, and privacy may be expected to increase as rejection rates increase. In this way, the privacy test rejects those gradients from batches that would leak private information.

Protections that non-limiting embodiments or aspects of PD-SGD offer may be analyzed in two complementary ways. A first way may ask why some batches pass the privacy tests while others do not. The second way may ask what privacy protection is provided if it is ensured that any batch is plausible deniable. Each way has its own set of theoretical results, which are presented herein below in more detail.

Consider a seed batch Bₛ, its associated gradient gₛ, and another batch Bᵢ with gradient gᵢ. Recall that a noisy candidate gradient \tilde{g}ₛ=gₛ+Z is plausibly deniable with respect to batch Bᵢ if Equation (1) holds. For example, plausibility (of \tilde{g}ₛ with respect to some gᵢ) may be denoted as the probability that Equation (1) holds:

$$q ( s , i ) = Pr [ {α}^{- 1} \leq \frac{p ( {\tilde{g}}_{s} - {g}_{s} )}{p ( {\tilde{g}}_{s} - {g}_{i} )} \leq α ] ,$$

where the probability q(s, i) is taken over the randomness of Z˜ [symbol] (0, σ²I). This probability may only depend on batches Bₛ and Bᵢ. The following result shows that this probability only depends on the l₂-distance between the two gradients, e.g., ∥gₛ−gᵢ∥₂.

Lemma 1. For any seed batch with gradient gₛ and any mini-batch with gradient gᵢ, let

$$d = {‖ {g}_{s} - {g}_{i} ‖}_{2}^{2} .$$

The probability that Equation (1) holds depends only on d, resulting in the following Equation (3):

$$q ( d ) = q ( s , i ) = Pr ( Y ∈ [ \frac{d - \tilde{γ}}{2 σ \sqrt{d}} , \frac{d + \tilde{γ}}{2 σ \sqrt{d}} ] ) , \qquad ( 3 )$$

where Y˜ [symbol] (0,1) and \tilde{γ}=2σ²γ. Lemma 1 shows that q(d) is exactly the probability that a standard normal variable takes a value in

$$[ \frac{d - γ}{2 σ \sqrt{d}} , \frac{d - \tilde{γ}}{2 σ \sqrt{d}} ]$$

where γ=2σ²γ. A proof of Lemma 1 is deferred here and provided below after discussion of example experiments. Intuitively, for a>b>0 the probability Pr(a−b≤Y≤a+b) can be reasonably approximated as 2bφ(a) where φ(·) is the standard normal pdf, and thus the probability falls exponentially fast with a.

The following results derived from tail bounds on Lemma 1 show that plausibility falls off exponentially fast with the l₂-norm d whenever d is sufficiently large with respect to \tilde{γ}. This immediately implies that any highly anomalous candidate gradient (e.g., a gradient with large l₂-norm to all other mini-batch gradients, etc.) will be rejected with high probability.

Lemma 2. For any seed batch with gradient gₛ and any mini-batch with gradient gᵢ, let d be defined as in Lemma 1 If d>2σ²γ, resulting in the following Equation (4):

$$q ( d ) < {C}_{d , γ , σ} \cdot exp ( - [ \frac{{d}^{2} + {\tilde{γ}}^{2}}{8 d {σ}^{2}} ] ) . \qquad ( 4 )$$

where

$${C}_{d , γ , σ} = \frac{\sqrt{2 d} σ}{\sqrt{π}} \cdot [ exp ( \frac{γ}{2} ) {( d - \tilde{γ} )}^{- 1} - ( d + \tilde{γ} ) \cdot exp {( - \frac{γ}{2} ) [ {( d + \tilde{γ} )}^{2} + 4 {σ}^{2} d ]}^{- 1} ] .$$

A proof of Lemma 1 is deferred here and provided below after discussion of example experiments.

A different way to analyze privacy is to consider what it means to be able to plausibly deny a batch and why the privacy test enables plausibly denying a batch. To understand this, consider a training iteration where a gradient update \tilde{g} is produced and the training dataset is partitioned into batches B, B₁, . . . , Bₘ. To plausibly deny batch B, consider the counterfactual where the batches are B₁, . . . , Bₘ (does not include B). Suppose batch B was indeed selected as the “seed” and produced g and that the test passed with many alternatives (e.g., t>>T). Then, there exists at least t−1 batches B′ among B₁, . . . , Bₘ such that the probability that \tilde{g} was produced if B is the “seed” is no more than a times the probability than if B′ is the seed. Informally, the probability of producing \tilde{g} when batch B is included cannot increase by more than a factor of (roughly)

$$( 1 + \frac{α}{t - 1} ) .$$

Referring now to FIG. 3B, shown is a flow chart for method 350 for using a machine learning model trained using a method for deep learning with plausible deniability, according to some non-limiting embodiments or aspects. The steps shown in FIG. 3B are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step.

As shown in FIG. 3B, at step 352, method 350 includes providing the trained machine learning model. For example, transaction processing system 101 may provide the trained machine learning model.

As shown in FIG. 3B, at step 354, method 350 includes receiving transaction data associated with a transaction currently being processed in electronic payment processing network 100. For example, transaction processing system 101 may receive transaction data associated with a transaction currently being processed in electronic payment processing network 100.

As shown in FIG. 3B, at step 356, method 350 includes processing, using the trained machine learning model, the transaction data to generate a prediction associated with the transaction. For example, transaction processing system 101 may process, using the trained machine learning model, the transaction data to generate a prediction associated with the transaction. The prediction may include a classification of the transaction as an anomalous transaction (e.g., a fraudulent transaction, etc.) or a non-anomalous transaction (e.g., a non-fraudulent transaction, etc.).

As shown in FIG. 3B, at step 358, method 350 includes authorizing or denying, based on the prediction, the transaction in electronic payment processing network 100. For example, transaction processing system 101 may authorize or deny, based on the prediction, the transaction in electronic payment processing network 100. As an example, transaction processing system 101 may authorize a transaction predicted to be a non-anomalous transaction, and/or transaction processing system 101 may deny a transaction predicted to be an anomalous transaction.

### Example Experiments

Assume a black-box membership adversary who knows a complete PD-SGD algorithm-privacy test rule, noise scale σ, threshold γ, neighbour count T—and the entire pool of candidate training records, but can only interact with the final trained model (or its API); the black-box membership adversary never sees per-iteration mini-batches, noisy gradients, or acceptance decisions. Assuming the final model is available for the adversary is a reasonable assumption which is a similar setting as hidden state differential privacy analyses that focus on the privacy of the final model parameters, while assuming the confidentiality of the training dynamics.

Three of the most commonly used datasets for evaluating membership inference attacks and DP-SGD are used: CIFAR-10, CIFAR-100 and Purchase-100. For the models, a ViT-B-16 model is fine tuned for CIFAR-10 and CIFAR-100, a linear model is fined tuned for Purchase-100, and a Wide ResNet is fined tuned for CIFAR-10 and CIFAR-100, training from scratch.

The adversary is considered to be a black-box attacker, who does not have access to the internal training process or parameters of the model but can observe its input-output behavior. To evaluate the robustness of defense mechanisms of non-limiting embodiments or aspects of PD-SGD against such adversaries, black-box membership inference attacks are employed using the Privacy Meter. From the Privacy Meter, the Population Attack (P-Attack), Reference Attack (R-Attack), Shadow model Attack (S-Attack) and Carlini Attack (C-Attack) are used. These four widely used attacks are employed to comprehensively evaluate empirical privacy leakage and make fair comparisons between different methods. A goal here is not to use the most exotic or recent attack, but to establish a fair empirical comparison between different defense methods and, thus, a well-understood set of popular recent membership inference attacks is used.

The utility and privacy of non-limiting embodiments or aspects of PD-SGD and other defense mechanisms are evaluated. Utility is primarily evaluated using the trained models' test accuracies and results on computational overhead. Privacy is evaluated using the selected set of four different membership inference attacks, namely P-Attack, R-Attack, S-Attack, and C-Attack. For the first three, the attack AUC score is reported. For C-Attack TPR at 0.1% FPR is reported.

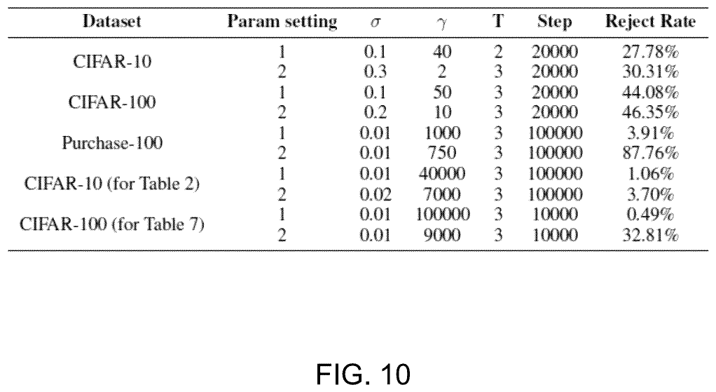

Two sets of hyperparameters may be used for non-limiting embodiments or aspects of PD-SGD. Parameter setting 1 is designed to optimize utility, while maintaining reasonable privacy, while parameter setting 2 prioritizes better privacy at the cost of lower accuracy. More details on tuning hyperparameters are provided below, and the table of FIG. 10 shows details of hyperparameters used in examples experiments.

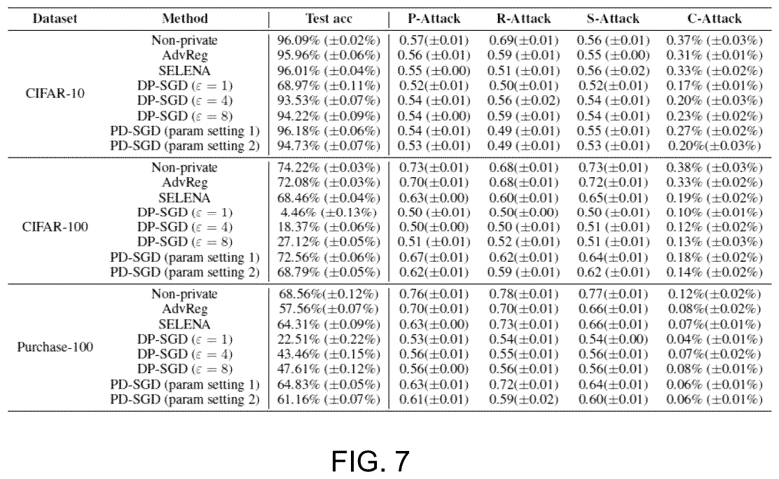

FIG. 7 is a table including results of evaluations of non-limiting embodiments or aspects of PD-SGD and other defense mechanisms. As shown in FIG. 7, non-limiting embodiments or aspects of PD-SGD, can achieve a better privacy-utility trade-off than other empirical defense mechanisms and DP-SGD. For example, non-limiting embodiments or aspects of PD-SGD, particularly with parameter setting 1, achieve comparable utility to non-private setting with a 96.15% test accuracy on CIFAR-10 and maintain robust performance on CIFAR-100 and Purchase-100, though slightly lower than some non-private baselines. Notably, PD-SGD exhibits stronger membership inference attack resilience than empirical defenses, with C-Attack performance being among the lowest recorded.

Furthermore, non-limiting embodiments or aspects of PD-SGD provide a favorable privacy-utility tradeoff even in cases where privacy is paramount (e.g., parameter setting 2, etc.). For example, there is only approximately 7% decrease in test accuracy to obtain a reduction in attack AUC of nearly 0.16 for Purchase-100, compared to the non-private baseline. Overall, findings show that non-limiting embodiments or aspects of PD-SGD achieve a superior trade-off between privacy and utility, surpassing empirical defenses.

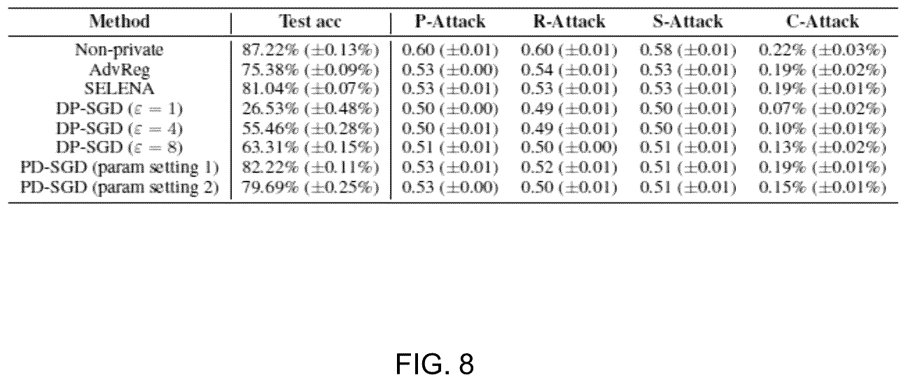

To demonstrate the generalizability of non-limiting embodiments or aspects of PD-SGD across different model architectures and training strategies, the evaluation may be extended to a ResNet-like architecture by training a Wide ResNet (WRN-16-4) model from scratch on the CIFAR-10 dataset. FIG. 8 is a table including results of evaluations of non-limiting embodiments or aspects of PD-SGD and other defense mechanisms on a ResNet-like model with Training from scratch. As shown in FIG. 8, non-limiting embodiments or aspects of PD-SGD also exhibit a superior privacy-utility trade-off compared to alternative defense mechanisms. Notably, non-limiting embodiments or aspects of PD-SGD with parameter setting 1 achieve a test accuracy of 82.14%, surpassing other privacy preserving methods such as SELENA (81.03%) and AdvReg (75.34%). Moreover, non-limiting embodiments or aspects of PD-SGD achieve a significantly lower vulnerability to membership inference attacks. For example, the R-Attack AUC score shows a marked decrease from 0.60 to 0.51 with parameter setting 2 of PD-SGD. The evaluation may be further extended to train WRN-28-2 from scratch on CIFAR-100, from which similar results are observed. For example, even using large & like 500 for DP-SGD, non-limiting embodiments or aspects of PD-SGD still achieve better utility and comparable membership privacy.

The privacy-utility tradeoff between methods is illustrated visually in the graph of FIG. 4. The x-axis shows the attack advantage and the y-axis shows the test accuracy for the WRN-16-4 model trained on CIFAR-10. Compared to DP-SGD, non-limiting embodiments or aspects of PD-SGD provide higher test accuracy for the same attack advantage even for high privacy cases (e.g., attack advantages close to 0, etc.). Compared to empirical defenses, non-limiting embodiments or aspects of PD-SGD not only can provide better utility with comparable attack advantage, but also offer a way to navigate the tradeoff (e.g., through the privacy parameter, etc.) and not (only) a fixed point on the privacy-utility landscape.

### Ablation Study

A set of ablation experiments can be performed to examine the effect of each component within non-limiting embodiments or aspects of PD-SGD. Reasons why non-limiting embodiments or aspects PD-SGD effectively protect privacy are, also, explored, and insights for hyperparameter tuning are provided.

Compared to (vanilla) SGD, non-limiting embodiments or aspects of PD-SGD may include two components: (1) noise addition to the seed batch's gradient, and (2) a plausible deniability-based privacy test. The following set of principled experiments is created to isolate the effect of these two components: (i) Only Noise: the threshold T=1, guaranteeing the privacy test will always pass; (ii) Only Privacy Test: use privacy test normally, but update parameters using the un-noised gradient; and (iii) Random Rejection: seed batches' gradients are randomly rejected at the same rate as non-limiting embodiments or aspects of PD-SGD.

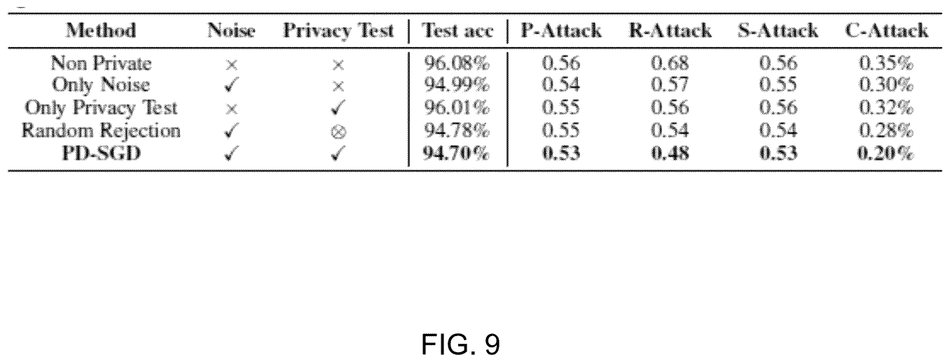

FIG. 9 is a table including results of evaluations of a privacy test and noise on non-limiting embodiments or aspects of PD-SGD. All hyperparameters may be maintained the same, only changing the threshold T to control the privacy test. In the table of FIG. 9, ✓ means the presence of noise or the application of a privacy test, x means the absence of these components, and ⊗ represents the use of random rejection for gradient updates instead of standard privacy testing. As shown in FIG. 9, adding noise to the gradient without the privacy test does not effectively defend against membership inference. The R-Attack success rate decreases substantially, but there is no substantial decrease for P-Attack, S-Attack, and C-Attack. Similarly, if the privacy test is used, but the gradient is un-noised or if updates are randomly rejected, there is again no major decrease in membership inference attack success rates. By contrast, non-limiting embodiments or aspects of PD-SGD exhibit the largest effect in mitigating membership inference attacks. The R-Attack success rate drops further to 0.48, and other attack vectors like P-Attack, S-Attack, and C-Attack are similarly reduced. These results demonstrate that a combination of the noise addition and the privacy test may provide the observed privacy protection of non-limiting embodiments or aspects PD-SGD.

As previously discussed, non-limiting embodiments or aspects of PD-SGD may include hyperparameters that can be tuned. For fair comparison, grid search may be performed for hyperparameters of the baselines used and non-limiting embodiments or aspects of PD-SGD. FIG. 10 is a table including hyperparameters used for the evaluations of FIGS. 7 and 8.

The relationship between different privacy parameters (σ, γ and T), batch size and rejection rate are discussed in more detail herein below. There are two broad strategies for tuning these parameters: leverage the theory or reliance on empirically successful heuristics.

Accordingly, non-limiting embodiments or aspects of the present disclosure may provide PD-SGD, a new approach for private learning without compromising performance. PD-SGD may be based on a rejection sampling approach using a privacy test. Theoretical and experimental results demonstrate that non-limiting embodiments or aspects of PD-SGD provide a superior privacy-utility trade-off compared to existing methods with provable privacy such as DP-SGD and empirical defenses, thereby making non-limiting embodiments or aspects of PD-SGD a promising solution for enhancing privacy protection in practical deep-learning applications.

### Proofs

Proof of Lemma 1. Considering the ratio of probabilities bounded by Equation (1) and expanding using the Gaussian PDF results in:

$$\begin{matrix}\frac{p ( {\tilde{g}}_{s} - {g}_{s} )}{p ( {\tilde{g}}_{s} - g )} = \frac{exp ( - {( 2 {σ}^{2} )}^{- 1} {\sum }_{j = 1}^{k} {Z}_{j}^{2} )}{exp ( - {( 2 {σ}^{2} )}^{- 1} {\sum }_{j = 1}^{k} {( {Z}_{j} + ( {g}_{s , j} - {g}_{i , j} ) )}^{2} )} \\ = exp ( - {( 2 {σ}^{2} )}^{- 1} {\sum }_{j = 1}^{k} [ {Z}_{j}^{2} - {( {d}_{j} + {Z}_{j} )}^{2} ] ) \\ = exp ( - {( 2 {σ}^{2} )}^{- 1} [ - d - 2 {\sum }_{j = 1}^{k} {d}_{j} {Z}_{j} ] ) ,\end{matrix}$$

where dⱼ=g_{s,j}−g_{i,j} and

$$d = {\sum }_{j = 1}^{k} {d}_{j}^{2} = {‖ {g}_{s} - {g}_{i} ‖}_{2}^{2} .$$

Plugging this into the inequality, taking the log and some reorganization, the candidate gradient is plausibly deniable with respect to gᵢ if:

$$- \frac{γσ}{\sqrt{d}} \leq \frac{\sqrt{d}}{2 σ} + {\sum }_{j = 1}^{k} \frac{{d}_{j}}{\sqrt{d}} \frac{{Z}_{j}}{σ} \leq \frac{γσ}{\sqrt{d}}$$

Since Z˜ [symbol] (0, σ²), the summand for j is distributed as

$$𝒩 ( 0 , {d}^{- 1} {d}_{j}^{2} ) .$$

Further, since the sum of i.i.d. Gaussian random variable is distributed as a Gaussian random variable with the sum of the means and the sum of the variance, it is recognized that

$${\sum }_{j = 1}^{k} \frac{{d}_{j}}{\sqrt{d}} \frac{{Z}_{j}}{σ} ∼ 𝒩 ( 0 , 1 ) .$$

Thus reducing the plausibility of a candidate gradient to the following Equation (5):

$$\frac{\sqrt{d}}{2 σ} - \frac{γσ}{\sqrt{d}} \leq Y \leq \frac{γσ}{\sqrt{d}} + \frac{\sqrt{d}}{2 σ} \qquad ( 5 )$$

and further to the following Equation (6):

$$\frac{d - 2 {γσ}^{2}}{2 σ \sqrt{d}} \leq Y \leq \frac{d + 2 {γσ}^{2}}{2 σ \sqrt{d}} \qquad ( 6 )$$

where symmetry is used so that −Y has the same distribution as Y. Therefore, Y needs to be within a band of width

$$\frac{\tilde{γ}}{σ \sqrt{d}}$$

around \sqrt{d}/2σ where \tilde{γ}=2σ²γ, which completes the proof.

The proof of Lemma 2 relies on the following standard normal upper and lower tail bounds:

Lemma 3. Let X˜N(0,1). For t>0, there is:

$$\frac{t}{{t}^{2} + 1} {( \sqrt{2 π} )}^{- 1} exp ( - {t}^{2} / 2 ) < Pr ( X > t ) < {( t \sqrt{2 π} )}^{- 1} exp ( - {t}^{2} / 2 ) .$$

Note that tighter bounds are available.

### Proof of Lemma 2. Let

$$a = \frac{\sqrt{d}}{2 σ} and b = \frac{γσ}{\sqrt{d}} .$$

From Lemma 1, it is known that q(s,i)=Pr(a−b≤X≤a+b) for X˜N(0,1). Thus:

$$\begin{matrix}q ( s , i ) = Pr ( X > a - b ) - Pr ( X > a + b ) \\ < \frac{1}{( a - b ) \sqrt{2 π}} {e}^{- {( a - b )}^{2} / 2} - \frac{( a + b )}{( {( a + b )}^{2} + 1 ) \sqrt{2 π}} {e}^{- {( a + b )}^{2} / 2} \\ = \frac{1}{\sqrt{2 π}} [ \frac{1}{a - b} {e}^{- {( a - b )}^{2} / 2} - \frac{( a + b )}{{( a + b )}^{2} + 1} {e}^{- {( a + b )}^{2} / 2} ] \\ = \frac{{e}^{\frac{- ( {a}^{2} + {b}^{2} )}{2}}}{\sqrt{2 π}} [ \frac{{e}^{ab}}{a - b} - \frac{( a + b )}{{( a + b )}^{2} + 1} {e}^{- ab} ]\end{matrix} .$$

Substituting back a and b in terms of d, σ, γ yields the result. The following corollary of the lemma provides a simple upper bound whenever d>\tilde{γ}. Corollary 1. Let

$$d \geq \frac{\tilde{γ}}{f}$$

for some 0<ƒ<1. Then:

$$q ( d ) < \frac{{e}^{- ( \frac{d}{8 {σ}^{2}} + \frac{{γ}^{2} {σ}^{2}}{2 d} )}}{\sqrt{2 π d}} 2 σ [ \frac{{e}^{γ / 2}}{1 - f} - \frac{{e}^{- γ / 2}}{2 + f} ] \qquad ( 7 )$$

Proof of Corollary 1. Let d≥2γσ² which implies a−b≥0. When d increases, a increases but b decreases. So, bounding a−b and a+b as follows:

Suppose b≤ƒ a where 0≤ƒ<1 and a>1, then

$$\frac{1}{a - b} \leq \frac{1}{a ( 1 - f )}$$

$$\frac{a + b}{{( a + b )}^{2} + 1} \geq \frac{1}{a ( 2 + f )}$$

Based on this, it can be determined that:

$$q ( s , i ) < \frac{{e}^{\frac{- ( {a}^{2} + {b}^{2} )}{2}}}{\sqrt{2 π}} [ \frac{{e}^{ab}}{a - b} - \frac{( a + b )}{{( a + b )}^{2} + 1} {e}^{- ab} ] < \frac{{e}^{\frac{- ( {a}^{2} + {b}^{2} )}{2}}}{\sqrt{2 π} a} [ \frac{{e}^{ab}}{1 - f} - \frac{{e}^{- ab}}{2 + f} ] .$$

Observe that ab=γ/2,

$${a}^{2} = \frac{d}{4 {σ}^{2}} , {b}^{2} = \frac{{γ}^{2} {σ}^{2}}{d}$$

### So:

$$q ( s , i ) < \frac{{e}^{- ( \frac{d}{8 {σ}^{2}} + \frac{{γ}^{2} {σ}^{2}}{2 d} )}}{\sqrt{2 π d}} 2 σ [ \frac{{e}^{γ / 2}}{1 - f} - \frac{{e}^{- γ / 2}}{2 + f} ] .$$

As described herein, privacy leakage results from including examples that distort the gradient. Lemma 2 and Corollary 1 imply that privacy leakage is guaranteed to be mitigated in the following sense. Any example causing a large distortion to the batch gradient, if included, will result in a failure to pass the privacy test with a high probability.

To see this observe the following. Consider an example within a batch that has a highly distorting impact on this batch's gradient

$${g}_{s}^{⋆}$$

compared to the batch's gradient without this example gₛ, i.e.,

$${‖ {g}_{s}^{⋆} - {g}_{s} ‖}_{2}^{2}$$

is large. If

$${g}_{s}^{⋆}$$

is also anomalous with respect to all other mini-batch gradients, i.e.,

$$d = {min}_{i} {‖ {g}_{s}^{⋆} - {g}_{i} ‖}_{2}^{2} \geq {‖ {g}_{s}^{⋆} - {g}_{s} ‖}_{2}^{2} ,$$

then, the probability of passing the privacy test with threshold T (assuming T>1) is at most (m−1)q(d) by union bound.

Further, by tuning γ and σ, q(d) can be made arbitrarily small and therefore (in principle) eliminate the privacy leakage of any example. However, the relationships between d, σ and γ are complex. There is a tradeoff between σ and γ in terms of satisfying Equation (1). Informally, for a fixed γ, the probability decreases exponentially with the ratio

$$\frac{d}{{σ}^{2}} .$$

If d is large, a large noise scale is required for plausibility (in which case privacy leakage is eliminated from the large noise). Conversely, with a small noise scale even relatively small deviations d are not plausible. Further details on the minimum d required for different values of δ, along with its dependency on γ and σ, are provided in herein below and illustrated in FIG. 3.

### Privacy Test Analysis

Consider a motivating example in which you just finished training a deep neural net on a carefully curated dataset and created an API to query the model. An adversary accuses you of having used some data as part of the training set. They take you to court and argue that your model could not have been obtained without their data. You know you did not use their data. But how could you plausibly deny the accusation?

Even if the burden of proof is not on you, it would be useful to provide the court with an execution trace that shows the model can be trained without inclusion of the adversary's data. This would undermine the adversary's claim. Unfortunately, providing a full execution trace is not without drawbacks. It may not be possible to reproduce a training even with a full trace, and it may require potentially divulging a bunch of confidential, and/or sensitive data or intellectual property.

Quantifying the probability that a particular set of model weights is obtained through training on a specific training dataset is intractable in general. Non-limiting embodiments or aspects of the present disclosure attempt to address a simpler problem: can the use of specific data during a single training iteration of an SGD-like learning algorithm be plausibly denied. And if so, what are the privacy implications? In the case of denying use of data for a model trained end-to-end, membership inference may be used to detect if the data was used during training, as many existing works have proposed. Therefore, data use for a model trained end-to-end can be denied, the model necessarily has to resist membership inference. Can the same be said if data used in a single training step is denied?

Focus on one gradient update step: the dataset is partitioned into batches; one batch is randomly selected; its gradient is computed through backpropagation; finally the model weights are updated based on this gradient. It can be hypothesized that the use of a batch during a training iteration can be plausibly denied, then the privacy of the dataset is protected in some meaningful way.

To ensure any batch can be plausibly denied, non-limiting embodiment or aspects of the present disclosure provide a modification of SGD. At each iteration non-limiting embodiment or aspects of the present disclosure may compute the gradient of a randomly selected batch, add some noise to this gradient, and perform a privacy test that compares this noisy gradient to the gradients of other batches. If the test passes, the noisy gradient is used to update the current model weights. Otherwise, the gradient is discarded and no updates to the weights are made. Intuitively, the test effectively prevents or inhibits “anomalous” gradient updates (compared to other batches) —these are precisely those batches that cannot plausibly be denied—from being applied and, therefore, influencing the model.

Non-limiting embodiments or aspects of the present disclosure, thus, provide a framework for plausible deniability. Let [symbol] denote the algorithm, X its input (which includes its parameters), and Y its output. An execution trace is a tuple ( [symbol] , X, R, Y) that fully specifies a run of algorithm [symbol] . Here R denotes the random choices that [symbol] makes. While the party who runs [symbol] may have a full execution trace, the adversary does not. The adversary may only have a partial trace where some elements are uncertain (e.g., the random choices R or parts of the input X or the parameters, etc.).

After the algorithm is run and some output Y is produced, all parties may be assumed to observe Y. The adversary's accusation is a partial trace with missing or unspecified elements. For example, if the adversary accusation is that the input contains some x then the partial trace may be of the form ( [symbol] , x∈X, Y). The adversary's accusation is interpreted as a hypothesis H₁. In the previous example, H₁ is that [symbol] was run on some input X (whatever it is) that contains x. To defend against this accusation, the party who ran [symbol] can produce one (or a set of execution traces) that supports the induced alternative hypothesis H₀, i.e., that [symbol] was run on some input X (whatever it is) that does not contain x³.

For a court, one or more full execution traces that support H₀ may be sufficient. A valid defense against the claim (e.g., a plausible denial) may be defined as the existence of those traces whether or not they can be easily constructed. For example, consider the following Definition 2. Let Y denote the observed output from [symbol] on some X. Let H₁ be the hypothesis that corresponds to the adversary's accusation about X and H₀ be the induced alternative hypothesis. The accusation can be λ-plausibly denied if:

$$\frac{Pr ( Y \vert {H}_{1} )}{Pr ( Y \vert {H}_{0} )} \leq λ ,$$

for some λ>1.

This definition is Pr(Y|H₀)>0 since Y the probabilities are over the random choices of the algorithm R and any other unspecified (part of the) inputs. It may be assumed that all parties agree about the distribution of unspecified inputs, which is not specified here because it is context dependent.

When applying this generic framework to an SGD-like algorithm, consider [symbol] to denote one iteration where its input is the training dataset D (or its partition into batches [symbol] ) and any parameters, and the output is the (possibly noisy) mini-batch gradient g (or \tilde{g}). (Vanilla) SGD has no plausible deniability because, given a batch B (and arbitrary loss function L and model weights θ) that yields some gradient g, there is no guarantee that there exists any other batch B′ in the data distribution that has the same gradient.

DP-SGD satisfies plausible deniability if the claim is that the batch B contains a single example (x, y). This is because DP-SGD adds noise to the average gradient of the batch B after clipping each per-example gradient and the noise added is also scaled to the clipping bound. Therefore, the batch B\{(x, y)} can be provided to plausibly deny the claim, and the α depends on the noise scale σ and the number of examples per batch. However, with DP-SGD, a batch B cannot be denied with another batch. That is, if the dataset is partitioned into a set of batches [symbol] =(B, B₁, B₂, . . . , Bₘ₋₁), another batch B′∈ [symbol] (B′≠B) cannot be exhibited as a way to deny the claim. Intuitively, this is because even after clipping per-example gradients and noise adding, there is no guarantee that any noisy gradient for any batch B′≠B is similar to the noisy gradient for B.

By contrast, non-limiting embodiments or aspects of PD-SGD enable denying any batch, for example, plausibly pretending it is not there, or that another batch was in its place (or that the batch was part of the validation set and not the training set, etc.). This is because the privacy test ensures that whenever a noisy gradient from a batch B is used to update parameters, there must have been at least T alternative batches that could plausibly have produced the same noisy gradient.

### Batch Deniability

The privacy of non-limiting embodiments or aspects of PD-SGD comes from the privacy test. To discuss properties of the test from Definition 1 and its implication, the concept of α-similarity is introduced. For a fixed \tilde{g}, two batches B₁, B₂ are α similar if

$${α}^{- 1} \leq \frac{p ( \tilde{g} \vert {B}_{1} )}{p ( \tilde{g} \vert {B}_{2} )} \leq α .$$

B₁≅_{α} B₂ may be written to denote α-similarity (and \tilde{g} may often be omitted when clear from the context). Note, it is shown herein below that there are variants of the privacy test that change the notion of α-similarity and have different properties. Fix \tilde{g} and a partition of batches [symbol] =(B₁, B₂, . . . , Bₘ). Suppose picking a seed batch B∈ [symbol] . Let τ(B; [symbol] , α)=|{B′∈ [symbol] : B≅_{α} B′}| be the number of a-similarity batches to B. For conciseness, α and [symbol] are omitted when clear from the context and τ(B) can be simply written. This is precisely the number of alternatives in Definition 1.

Observe that the τ(B, [symbol] ) is stable over any removal or addition of a batch B′≠B to/from [symbol] . Indeed: Δ=|τ(B; [symbol] )−τ(B; [symbol] )|=1 for any [symbol] , [symbol] that include B and differ in at most one batch. In other words, the sensitivity is 1. Also, there is for τ(B; [symbol] , α)≤τ(B; [symbol] , α′) for any α′>α. Furthermore, let [symbol] _{α}(B) denote the set of batches B′∈ [symbol] such that B≅_{α} B′. If τ(B; [symbol] )≥2k+1, then there exists B′≠B∈ [symbol] _{α}(B) such that τ(B; [symbol] \B)≥k. For example, if batches B has at least 2k+1 alternative, then if batch B is removed, there still exists at least k batches that are pairwise α-similar among the set initially α-similar with B.

Lemma 4. Fix an arbitrary observed \tilde{g}. Consider an any accusation of the form [symbol] =(B, B₁, . . . , Bₘ). If privacy parameters were (α, σ, T) for T≥2T′+1 (for some T′>1), then the presence of batch B can be λ-plausibly denied with privacy parameters (α, σ, T′) for

$$λ = \frac{m}{m + 1} ( 1 + \frac{2 α}{m} ) .$$

Proof. Following Definition 2 it suffices to show that:

$$\frac{P r ( \tilde{g} \vert ( B , {B}_{1} , … , {B}_{m} ) ; T )}{P r ( \tilde{g} \vert ( {B}_{1} , … , {B}_{m} ) ; {T}^{′} )} \leq λ ,$$

where the probabilities are taken over the selection of the seed batch (since the rest is fixed). For conciseness write: [symbol] =(B, B₁, . . . , Bₘ) and [symbol] =(B₁, . . . , Bₘ). There is:

$$Pr ( \tilde{g} \vert {ℬ}^{′} ; T ) = \frac{1}{m + 1} ( Pr ( \tilde{g} \vert B is seed , {ℬ}^{′} ) + {\sum }_{i} Pr ( \tilde{g} \vert {B}_{i} is seed , {ℬ}^{′} ) )$$

For any batch B and partition [symbol] :

$$P r ( \tilde{g} \vert B , ℬ ) = p ( \tilde{g} \vert B ) \cdot {1}_{τ ( B , ℬ ) \geq T} .$$

Therefore, the probability of producing \tilde{g} conditional on B being the seed and the partition being [symbol] is the product of (1) the probability that \tilde{g} is the noisy gradient from batch B and (2) the probability of passing the test. For (1) there is p(\tilde{g}|B)=p(g|g(B))=p(\tilde{g}−g(B)) (where g(B) denotes the gradient of batch B). For (2), the test only depends on whether there are at least T alternatives to B in [symbol] .

Observe that Pr(g|B, [symbol] , T)=p(\tilde{g}|B)· [symbol] ≤(T′)⁻¹αPr(\tilde{g}|B′, [symbol] , T) since there exists at least T′ batches B′∈ [symbol] such that p(\tilde{g}|B)≤αp(\tilde{g}|B′). Further, since any batch B∈ [symbol] that passes the test with T also passes it with T′, the ratio is bounded by

$$\frac{m}{m + 1} ( 1 + \frac{α}{{T}^{′}} ) .$$

In the most stringent case of the privacy parameters, set T=m+1 so that T′=m/2 and choose α close to 1 (e.g., γ close to 0). This gives a bound of

$$\frac{m}{m + 1} ( 1 + \frac{2 α}{m} ) .$$

In the following section a number of privacy tests variants are introduced. The intuition behind the method (and Definition 1) is to ensure that the only gradients that are released (e.g., pass the privacy test) are those likely to be produced even if removing any given batch. If that is the case, the probability of releasing \tilde{g} conditional on the privacy test passing remains (relatively) stable under the addition or removal of a batch. For example, the privacy test may act as a local Lipschitz condition that bounds the change due to any one batch.

### Privacy Test Variants

Not all privacy tests yield the same plausible deniability. The test of Definition 1 is relatively simple and performs well in practice, but it has a downside that is that it is possible to construct (edge cases) where τ(B, [symbol] ) increases by more than 1 when adding or removing on batch to [symbol] . A test where the quantity τ(B, [symbol] ) for any batch B and partition [symbol] can never change by more than 1 when adding or removing a batch (or changing a batch by adding or removing one or more of its examples) may be more ideal. In other words, the sensitivity is 1 for any batch change. There are two simple variants of the privacy test that have this property. It suffices to redefine the notion of α-similarity.

Integer (“Bins”) Test. Define two batches B, B′ to be α-similar if └log_{α}(p(\tilde{g}|B)┘=└log_{α}(p(\tilde{g}|B′)┘. In words, the batches are similar if their probabilities of producing \tilde{g} fall into the same integer α-bin. Since the bins are fixed (e.g., only batches B such that α⁻ⁱ≤p(\tilde{g}|B)<α⁻ⁱ⁺¹ fall in bin i) adding or removing a batch only affects one bin. Therefore, the count in bin i, τ(B, [symbol] ) can only change by 1.

Stable (“Clique”) Test. Define a collection of batches B₁, B₂, . . . , Bₖ to be α-similar (in the clique sense) if for any two i, j∈1, 2, . . . , k there is:

$${α}^{- 1} \leq \frac{p ( \tilde{g} \vert {B}_{i} )}{p ( \tilde{g} \vert {B}_{i} )} \leq α .$$

This may be referred to as a “clique”, because once \tilde{g} is fixed and [symbol] is partitioned, the graph where each batch B∈ [symbol] is a node and two batches B, B′ are connected by an edge if

$${α}^{- 1} \leq \frac{p ( \tilde{g} \vert {B}^{′} )}{p ( \tilde{g} \vert B )} \leq α$$

can be imagined. In this graph, the largest clique that includes some batch B defines the collection of batches including B that is α-similar. Under this definition, a batch B∈ [symbol] may only be included in exactly one a-similar clique/group. Further, if adding or removing one batch, it only affects one clique and reduces/increases its size by one, so the sensitivity of this test is 1. Experiments are discussed, herein, below to compare different variants of the privacy test.

Randomized Thresholds. To show that PD-SGD can achieve (ε, δ)-differential privacy, consider a randomized version of the test that also caps the probability of passing the test. For example, given the count τ of alternatives for the seed batch (according to whatever notion of α-similarity is being used), randomize the test based on noise z˜Geom(β) so that the test passes if τ+z≥T. Define z˜Geom(β) for β>1 so that

$$Pr ( z = i ) = \frac{β - 1}{β + 1} {β}^{- \vert i \vert}$$

for any integer i.

The probability of passing the test is [symbol] [1_{τ+2≥T}], where τ+z can be thought of as a noisy count. For conciseness, write p_{τ}=Pr(z≥T−τ) to denote the probability that the test passes given the count τ. Each privacy test variants may be such that the probability of passing the test only depends on τ. When using a test, such that the sensitivity of τ is 1, the probability of passing the test when adding or removing one batch changes only by a bounded amount (e.g., by at most a factor of β when increasing τ by 1).

Adding a Ceiling. The leakage in a DP-sense can be further reduced by adding a ceiling on the probability of passing the test as follows. If the test passes (e.g., τ+z≥T), a coin flip with probability of heads 1−ψ (for some ψ>0) can be used. If the coin lands on heads, the test passes. Otherwise, the test fails. This means the probability of passing the test is p_{τ}=(1−ψ)Pr(τ+z≥T). For example, if ψ=0.2, the test never passes with probability higher than 0.8.

Properties. Putting all of this together, there are the following properties for any test that uses the integer or stable definition of α-similarity, randomizes thresholds˜Geom(β) and include the ceiling 1−ψ. Lemma 5, There is:

$$1 \leq \frac{{p}_{τ + 1}}{{p}_{τ}} \leq β and 1 \geq \frac{1 - {p}_{τ + 1}}{1 - {p}_{τ}} \geq \frac{ψ}{1 - \frac{1 - ψ}{β}} .$$

The lemma states that the probability of passing the test is non-decreasing as a function of τ and, when increasing the count by one (e.g., if adding a batch), the probability of passing the test increases by a factor of at most β. Further, the change in probability of failing the test due to increasing the count by one has a lower bound as a function of β and ψ.

Proof. Because T−τ decreases with τ, the event {z≥T−τ} becomes easier as τ grows; hence:

$${p}_{τ + 1} \geq {p}_{τ} .$$

Upper ratio. The geometric tail satisfies

$$Pr [ z \geq k ] = \frac{β}{β + 1} {β}^{- k} ,$$

so for p_{τ+1}<1−ψ, therefore:

$$\frac{{p}_{τ + 1}}{{p}_{τ}} = \frac{{β}^{- ( T - τ - 1 )}}{{β}^{- ( T - τ )}} = β .$$

If p_{τ+1}=1−ψ, then p_{τ+1}/p_{τ}≤1<β. Lower bound on (1−p_{τ+1})/(1−p_{τ}). Based on upper ratio, there is:

$$\frac{1 - {p}_{τ + 1}}{1 - {p}_{τ}} \geq \frac{1 - {p}_{τ + 1}}{1 - \frac{{p}_{τ + 1}}{β}}$$

Since

$$\frac{1 - {p}_{τ + 1}}{1 - \frac{{p}_{τ + 1}}{β}}$$

is monotonically decreasing and p_{τ+1}≤1−ψ, it results in:

$$\frac{1 - {p}_{τ + 1}}{1 - \frac{{p}_{τ + 1}}{β}} \geq \frac{ψ}{1 - \frac{1 - ψ}{β}}$$

Further, when τ is far from the threshold T, the test passes with exponentially small probability. This matters for differential privacy as it translates into δ. The following result makes this precise.

Lemma 6. For any 1≤t<T, the probability of passing the test with t alternatives, pₜ is upper bounded as follows:

$${p}_{t} \leq ( 1 - ψ ) exp ( - {ε}_{0} ( T - t ) ) ,$$

where ε₀=ln β.

### Proof.

$${p}_{t} = ( 1 - ψ ) Pr ( z \geq T - t ) = ( 1 - ψ ) \frac{β - 1}{β + 1} {\sum }_{i \geq T - t} {β}^{- ( T - t )} \leq ( 1 - ψ ) {β}^{- ( T - t )} = ( 1 - ψ ) exp ( - {ε}_{0} ( T - t ) )$$

### Differential Privacy

Non-limiting embodiments or aspects of PD-SGD can be shown to satisfy (ε, δ)-differential privacy. Referring again to FIG. 6, let [symbol] denote a single training iteration. Let Pr(S| [symbol] (D))=Pr( [symbol] (D)∈S) denote the probability that, when invoked on D, [symbol] produces an output in set S. For an arbitrary output set Y∈Range( [symbol] ) and any two neighboring datasets D₁, D₂ (where D₂ can be obtained from D₁ by adding a single example (x, y) or vice versa), three is: Pr(S| [symbol] (D₁)≤e^{ε}Pr(S| [symbol] (D₂)+δ. Before stating the result and providing it, consider how M works. First, the algorithm randomly partitions the dataset into m batches. Then, a seed batch out of the m batches is chosen uniformly at random. The gradient of this seed batch is computed and noise is added to obtain a candidate noisy gradient. Finally, the privacy test is evaluated. If it passes the noisy gradient is released, otherwise the output ⊥ (no updates). This means:

$$Pr ( S \vert ℳ ( D ) ) = \frac{1}{\vert ℬ ( D ) \vert} {\sum }_{𝔅 ∈ ℬ ( D )} \frac{1}{m} {\sum }_{i = 1}^{m} Pr ( S \vert {B}_{i} is seed , 𝔅 ) ,$$

where [symbol] (D) denotes all possible partitions of D into m batches and [symbol] denotes a partition into m batches. The probability is over the random choice of the partition, the random choice of seed batch given the partition, and the noise on the gradient and whether the test passes (which is also random due to randomization of the threshold).

An insight is that when considering D′=D∪{(x, y)} the additional example (x, y) ends up in exactly one batch (keeping the number of batches constant to m). This means partitions of D are coupled to partitions of D′ and account for the (uniformly random) batch that (x, y) falls into. From there, the results only rely on Lemmas 5 and 6.

Lemma 7. Let [symbol] denote a single training iteration 1 using a sensitivity 1 privacy test with randomized threshold and ceiling. Let m>1 denote the number of batch and (T, a, α, β, ψ) denote the privacy parameters. For any two neighboring datasets D₁, D₂, any output set S and any integer 1≤t<T, [symbol] satisfies (ε, δ)-differential privacy. That is:

$$Pr ( Y \vert ℳ ( {D}_{1} ) ) \leq {e}^{ε} Pr ( Y \vert ℳ ( {D}_{2} ) ) + δ ,$$

where

$$ε = ln ( 1 + \frac{1}{t} αβ ) and δ \leq \frac{1}{m} ( 1 - ψ ) exp ( - {ε}_{0} ( T - t ) ) .$$

Here ε₀=ln β, α=exp(γ).

Proof. First, (with slight abuse of notation) consider the case of a fixed output gradient \tilde{g}. Write:

$$Pr ( \tilde{g} \vert ℳ ( D ) ) = \frac{1}{\vert ℬ ( D ) \vert} {\sum }_{𝔅 ∈ ℬ ( D )} \frac{1}{m} {\sum }_{i = 1}^{m} Pr ( \tilde{g} \vert {B}_{i} , 𝔅 ) ,$$

where Pr(\tilde{g}|Bᵢ, [symbol] ) is written to mean Pr(\tilde{g}|Bᵢ is seed, [symbol] ) for conciseness. Recall that Pr(\tilde{g}|B, [symbol] )=p(\tilde{g}|B)·p_{τ(B,} [symbol] ₎.

Consider adding an example (x, y) to D. Let D′=D∪{(x, y)}. Observe that no matter how D′ gets partitioned (assuming only m batches) the example (x, y) only falls into one batch. Further, since it is equally likely to fall into any batch under a random partition, the partition [symbol] under D′ can be coupled to each partition [symbol] under D as follows. Choose a uniformly random partition [symbol] of D with m batches, then pick a batch index i*∈{1, 2, . . . , m} for (x, y) to fall into and finally obtain [symbol] ′ from [symbol] by adding (x, y) to batch B_{i*}. This ensures that [symbol] ′ is a uniformly random partition of D′. Therefore, fix an arbitrary partition [symbol] of D and let [symbol] ′ be the associated partition under D′. Write Pr(\tilde{g}| [symbol] ′) and relate it to Pr(\tilde{g}| [symbol] ) by considering the batch (x, y) falls into. There is:

$$Pr ( \tilde{g} \vert ) = \frac{1}{m} Pr ( \tilde{g} \vert B ⋃ \{ ( x , y ) \} , ) + \frac{m - 1}{m} Pr ( \tilde{g} \vert B , ) , \qquad ( 8 )$$

where B is a randomly selected batch from [symbol] ′ that does not include (x, y), i.e., B is a randomly selected batch from [symbol] .

Working from Equation (8), get the first direction:

$$Pr ( \tilde{g} \vert ) > \frac{m - 1}{m} Pr ( \tilde{g} \vert B , ) \geq \frac{m - 1}{m} Pr ( \tilde{g} \vert B , ) = \frac{m - 1}{m} Pr ( \tilde{g} \vert )$$

where the first inequality used the fact that Pr(\tilde{g}|B∪{(x, y)}, [symbol] ′)>0 and the second used Lemma 5 (the probability of passing the test is non-decreasing). For the second direction, observe that the term Pr(\tilde{g}|B, [symbol] ′) is related to Pr(\tilde{g}|B, [symbol] ) as follows:

$$Pr ( \tilde{g} \vert B , ) = p ( \tilde{g} \vert B ) \cdot \leq β p ( \tilde{g} \vert B ) \cdot = β Pr ( \tilde{g} \vert B , ) .$$

Where the inequality relies on Lemma 5. Since [symbol] ′ differs in only one batch from [symbol] the count of alternative increases by at most one and, thus, the probability of passing the test by a factor of at most β.

Dealing with the term

$$\frac{1}{m} Pr ( \tilde{g} \vert B ⋃ \{ ( x , y ) \} , )$$

requires dividing the analysis into two cases. Write B*=B∪{(x, y)} for conciseness. Case 1: τ(B*, [symbol] ′)>t. In this case for any batch B∈ [symbol] ′ that is α-similar to B* there is τ(B*, [symbol] )≥t (and there are at least t such batches). Therefore, if comparing Pr(\tilde{g}|B*, [symbol] ′) to that of a uniformly random selection of B∈ [symbol] there is:

$$Pr ( \tilde{g} \vert {B}^{*} , ) \leq \frac{αβ}{t} {\sum }_{B ∈ : {B}^{*} ≃ {}_{α} B} Pr ( \tilde{g} \vert B , ) \leq \frac{αβ}{t} {\sum }_{B ∈} Pr ( \tilde{g} \vert B , )$$

where the first inequality applies the α-similarity and Lemma 5 to the average batch B∈ [symbol] that is α-similar to B*. The second inequality simply uses the fact that Pr(\tilde{g}|B, [symbol] )≥0 for any batch B.

Now, since

$$\frac{1}{m} Pr ( \tilde{g} \vert B , )$$

is the expectation that is therefore upper bounded by the expectation over a random batch B∈ [symbol] , there is:

$$\frac{1}{m} Pr ( \tilde{g} \vert {B}^{*} , ) \leq \frac{α β}{t} Pr ( \tilde{g} \vert B , )$$

Putting this together, there is for case 1 that:

$$Pr ( \tilde{g} \vert ) \leq \frac{α β}{t} Pr ( \tilde{g} \vert B , ) + \frac{m - 1}{m} β Pr ( \tilde{g} \vert B , ) \leq α β ( \frac{m - 1}{m} + \frac{1}{t} ) Pr ( \tilde{g} \vert ) .$$

For case 2: τ(B*, [symbol] ′)≤t. In this case, there are less than t alternatives in [symbol] (e.g., there could be none). However, since the term Pr(\tilde{g}|B*, [symbol] ′) is bounded by the probability of passing the test according to Lemma 6. There is:

$$\frac{1}{m} Pr ( \tilde{g} \vert B ⋃ \{ ( x , y ) \} , ) \leq \frac{1}{m} ( 1 - ψ ) exp ( - {ε}_{0} ( T - t ) ) p ( \tilde{g} \vert {B}^{⋆} ) .$$

### Therefore:

$$Pr ( \tilde{g} \vert ) \leq \frac{1}{m} ( 1 - ψ ) exp ( - {ε}_{0} ( T - t ) ) \cdot p ( \tilde{g} \vert {B}^{⋆} ) + \frac{m - 1}{m} β Pr ( \tilde{g} \vert ) .$$

### Since

$$\frac{m - 1}{m} β \leq α β ( \frac{m - 1}{m} + \frac{1}{t} ) ,$$

this completes the second direction and resulting in:

$$Pr ( \tilde{g} \vert ) \leq α β ( \frac{m - 1}{m} + \frac{1}{t} ) Pr ( \tilde{g} \vert ) + δ ( \tilde{g} , {β}^{*} ) ,$$

where

$$δ ( \tilde{g} , {β}^{*} ) = \frac{1}{m} ( 1 - ψ ) exp ( - {ε}_{0} ( T - t ) ) \cdot p ( \tilde{g} \vert {B}^{*} ) ,$$

However, to meet the definition for both directions, consider an arbitrary set of gradients Y not just a single \tilde{g}∈Y. It suffices to integrate over the previous results. Since: Pr(Y| [symbol] )=Σ_{\tilde{g}∈Y} Pr(\tilde{g}| [symbol] ′), it follows that:

$$\frac{m - 1}{m} Pr ( Y \vert ) \leq Pr ( Y \vert ) \leq α β ( \frac{m - 1}{m} + \frac{1}{t} ) Pr ( y \vert ) + δ ( Y , {β}^{⋆} ) ,$$

where

$$δ ( Y , {β}^{⋆} ) = \frac{1}{m} ( 1 - ψ ) exp ( - {ε}_{0} ( T - t ) ) \cdot {\sum }_{\tilde{g} ∈ Y} p ( \tilde{g} \vert {B}^{⋆} ) \leq \frac{1}{m} ( 1 - ψ ) exp ( - {ε}_{0} ( T - t ) )$$

because Σ_{\tilde{g}∈Y} p(\tilde{g}|B*) is at most 1 since it is a probability distribution.

Noting that

$$Pr ( Y \vert ( D ) ) = \frac{1}{\vert ℬ ( D ) \vert} Pr ( Y \vert )$$

and the number of partitions in the sum from the coupling is the same for D and D′ yields the result with

$$ε = ln ( α β ( 1 + \frac{1}{t} ) ) and δ \leq \frac{1}{m} ( 1 - ψ ) exp ( - {ε}_{0} ( T - t ) ) ,$$

Parameter Tuning. Lemma 7 shows that with an appropriate variant of the privacy test, non-limiting embodiments or aspects of PD-SGD achieve (ε, δ)-differential privacy. Interestingly, it is possible to tune the parameters, so the guarantee is stringent. To ensure a small δ it is desirable to set t such that T−t is relatively large. For example, set T and t such that which requires and ensures that

$$exp ( - {ε}_{0} ( T - t ) ) = \frac{1}{\vert D \vert}$$

which requires

$$T = \frac{ln \vert D \vert}{{ε}_{0}} + t$$

and ensures that

$$δ \leq \frac{1}{m} ( 1 - ψ ) \frac{1}{\vert D \vert} .$$

That is δ asymptotically smaller than |D|⁻¹ if considering a fixed batch size (so that as |D| increases so does m). In such a case, there is

$$ε = γ + {ε}_{0} + ln ( 1 + \frac{1}{τ} ) = γ + {ε}_{0} + ln ( 1 + {( T - \frac{ln \vert D \vert}{{ε}_{0}} )}^{- 1} ) .$$

Note that T≤m, so everything else being equal, it appears to be more challenging to get good privacy for a smaller number of batches.

Gradient Rejections. Although the adversary never observes rejected gradients (⊥), it can be shown that even if an adversary could observe them, the leakage would be bounded in terms of differential privacy. Since the probability of passing the test has a ceiling, adding or removing an example to/from a batch only changes the probability of rejection by a bounded amount.

It can be shown that:

$$\frac{ψ}{m} + \frac{m - 1}{m} \frac{β ψ}{( β - 1 ) + ψ} \leq \frac{Pr ( ⊥ \vert ( {D}^{′} ) )}{Pr ( ⊥ \vert ( D ) )} \leq \frac{1}{m ψ} + \frac{m - 1}{m ψ} \leq 1 + \frac{1}{m ψ} .$$

This follows from Lemma 5.

Composition. Since the iterations are independent, advanced composition can be applied to obtain an overall guarantee. So for N update steps there is:

$${ε}^{′} = \sqrt{2 N ln ( \frac{1}{{δ}^{″}} )} ε + N ε ( {e}^{ε} - 1 ) and {δ}^{′} = N δ + {δ}^{″} ,$$

where (ε′, δ′) is the privacy budget for an entire training run and 1>>δ″>0 can be freely chosen to control the tradeoff between ε′ and δ′.

### Adaptive Attacks

Adaptive attacks are an important consideration in evaluating new defense mechanisms. If selecting the test and privacy parameters to achieve DP, adaptive attacks are not a concern. But even if not, it is unclear how one could construct adaptive membership-inference attacks against DP-SGD that surpass the effectiveness of existing non-adaptive methods in this setting.

The privacy test and Lemma 2 mean that updates g close to the anomalous gradients are extremely unlikely. So the adversary has to focus on likely noisy gradients updates \tilde{g} such that the probabilities of P(\tilde{g}|(x, y) member) and P(\tilde{g}|(x, y) non-member) are very different. But if there are sufficiently many alternatives, the ratio of these probabilities is bounded (as discussed herein above). The adversary can try to focus on cases in which adding or removing examples (x, y) changes the probability of passing the test, but this fails because the adversary does not observe updates directly (or lack of updates); they cannot know if the test passed at a given iteration. Further, this can be mitigated by randomizing the test threshold and adding a ceiling.

The best the adversary can hope for is that the presence of (x, y) in the dataset slowly nudges the model (over many, many training iterations) to yield different losses on (x, y) when included versus not. However, this is exactly what the current (non-adaptive) MIA does. They evaluate the loss of the model on (x, y) and based on predicting a member or a non-member.

Comparison with SGD and DP-SGD

Algorithmic Complexity. Compared to SGD, non-limiting embodiments or aspects of PD-SGD may only perform a single update of model parameters in each step. This update may only occur if the privacy test passes, and if it requires computing up to m batches' gradients. Checking Equation (2) is reasonably efficient in practice, so a main computational bottleneck is the computations of the gradients. However, observe that when the rejection rate is expected to be low, non-limiting embodiments or aspects of PD-SGD may often not need to compute all m batches' gradients to pass the test. In example experiments discussed herein, it is found that, although, non-limiting embodiments or aspects of PD-SGD may be slower than SGD, non-limiting embodiments or aspects of PD-SGD are often much faster than DP-SGD for a single training step, in large part because non-limiting embodiments or aspects of PD-SGD do not require calculating per-example gradients.

Non-decomposable Losses. Because non-limiting embodiments or aspects of PD-SGD may operate at the batch-level (unlike DP-SGD), non-limiting embodiments or aspects of PD-SGD may not care whether the loss function is decomposable or not. Non-decomposable loss functions are those where the batch gradient cannot be written as a sum of the individual example gradients.

### Privacy Parameter Tuning

There are two main strategies to approach parameter tuning. Theory-based strategy: Tuning parameters based on the rejection rate theory from Lemma 2 as explained herein, by tuning σ and γ, q(d) can be made arbitrarily small. If there is a desired bound on d, combinations of σ and γ can be found that achieve the desired effects. This can, for example, be done through a grid search.

To provide intuition and guide parameter tuning, plot the minimum d such that q(d) is at most some δ>0 as a function of γ and σ. For example, for δ=0.05 and δ=10⁻⁵, which plots \sqrt{d/k}, where k is the dimension of the gradient vector (i.e., g∈ [symbol] ^{k}) that used here for normalization. It can be observed that (as expected) a larger d* is required for the same σ and γ for q(d)<10⁻⁵ compared to q(d)<0.05. Moreover, for a fixed q(d), the normalized distance d′ appears to grow with the product of σ and γ. This is consistent with Lemma 2, which suggests that the asymptotic behavior is driven by the product σ²γ. Furthermore, when tuning the privacy parameters, exploring combinations of σ and γ such that σ²γ remains roughly constant is a sensible strategy. Alternatively, parameters can be tuned based on the connection between plausible deniability and differential privacy. For example, by setting T≥ε₀⁻¹ ln |D|+t to ensure a low enough δ. In that case

$$ε = γ + {ε}_{0} + ln ( 1 + \frac{1}{t} ) ,$$

where minimizing γ maximizes privacy. However, if the chosen pair (γ, σ) does not allow passing the test often enough, then utility suffers. Keeping σ²γ roughly constant to ensure a reasonable rejection rate and tuning other parameters, such as T, also, makes sense.

Empirical strategy: Alternatively, the following two-step strategy is easy to follow and yields good trade-offs. Step 1: tune the noise σ to achieve acceptable utility, ignoring the privacy test. This helps determine an upper limit for utility. Step 2: tune γ and the threshold T, which allows for fine-grained control over the privacy-utility trade-off. This approach is used in example experiments discussed herein. A useful heuristic, while tuning γ and T is to monitor the rejection rate. However, note that there exists favorable trade-offs for a wide-range of rejection rates, and a useful rule of thumb is, therefore, only to avoid extreme values (e.g., 0%—no privacy guarantee; 100%—no utility/full privacy).

### Computational Time

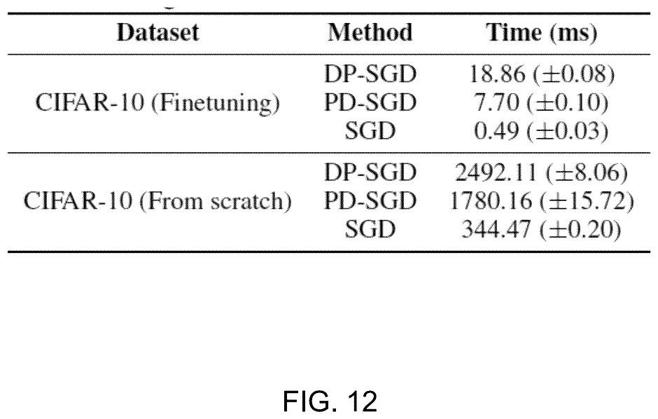

Example experiments evaluated the running time of non-limiting embodiments or aspects of PD-SGD for one training step by conducting experiments using CIFAR-10 by fine-tuning the ViT model, following the same setup as described for the table of FIG. 7. The WRN-16-4 model was, also, trained from scratch following the same setting in the table of FIG. 8. The time is averaged over three consecutive steps taken from the middle of the training process. For comparison, the time of standard SGD and DP-SGD under were also measured under the same conditions. The results are summarized in the table of FIG. 12. As demonstrated, non-limiting embodiments or aspects of PD-SGD is noticeably slower than standard SGD but notably faster than DP-SGD for a single training step.

Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

What is claimed is:

1. A system, comprising:
at least one processor configured to:
(i) obtain a dataset including a plurality of batches of data samples;
(ii) compute a plurality of gradients of the plurality of batches of data samples;
(iii) select a gradient of the plurality of gradients;
(iv) add noise to the selected gradient to generate a noised gradient;
(v) determine, based on the noised gradient and the plurality of gradients, a number of gradients of the plurality of gradients that satisfy a privacy function;
(vi) in response to the number of gradients of the plurality of gradients that satisfy the privacy function satisfying a threshold number, train, using the noised gradient, a machine learning model; and
(vii) in response to the number of gradients of the plurality of gradients that satisfy the privacy function failing to satisfy the threshold number, reshuffle the dataset to generate an updated plurality of batches of data samples and returning to step (ii).

2. The system of claim 1, wherein the noise added to the selected gradient to generate the noised gradient includes an isotropic Gaussian noise.

3. The system of claim 2, wherein the privacy function is defined according to the following Equation:
$${α}^{- 1} \leq \frac{p ( {\tilde{g}}_{s} - {g}_{s} )}{p ( {\tilde{g}}_{s} - {g}_{i} )} \leq α$$
where α=exp(γ) for some γ>0, p(·) denotes the density of the isotropic Gaussian noise [symbol] (0, Iσ²), gₛ is the selected gradient, \tilde{g}ₛ is the noised gradient, and gᵢ is a gradient of the plurality of gradients.

4. The system of claim 1, wherein the privacy function is defined according to the following Equation:
$$\vert ln p ( z ) - ln p ( {\tilde{g}}_{s} - {g}_{i} ) \vert \leq γ$$
where γ>0, p(·) denotes the density of the noise z, \tilde{g}ₛ is the noised gradient, and gᵢ is a gradient of the plurality of gradients.

5. The system of claim 1, wherein the gradient of the plurality of gradients is randomly selected.

6. The system of claim 1, wherein the data samples are associated with transactions in an electronic payment processing network, and wherein the at least one processor is further configured to:
provide the trained machine learning model;
receive transaction data associated with the transaction currently being processed in the electronic payment processing network;
process, using the trained machine learning model, the transaction data to generate a prediction associated with the transaction; and
authorize or deny, based on the prediction, the transaction in the electronic payment processing network.

7. The system of claim 6, wherein the prediction includes a classification of the transaction as a fraudulent transaction or a non-fraudulent transaction.

8. A method, comprising:
(i) obtaining, with at least one processor, a dataset including a plurality of batches of data samples;
(ii) computing, with the at least one processor, a plurality of gradients of the plurality of batches of data samples;
(iii) selecting, with the at least one processor, a gradient of the plurality of gradients;
(iv) adding, with the at least one processor, noise to the selected gradient to generate a noised gradient;
(v) determining, with the at least one processor, based on the noised gradient and the plurality of gradients, a number of gradients of the plurality of gradients that satisfy a privacy function;
(vi) in response to the number of gradients of the plurality of gradients that satisfy the privacy function satisfying a threshold number, training, with the at least one processor, using the noised gradient, a machine learning model; and
(vii) in response to the number of gradients of the plurality of gradients that satisfy the privacy function failing to satisfy the threshold number, reshuffling, with the at least one processor, the dataset to generate an updated plurality of batches of data samples and returning to step (ii).

9. The method of claim 8, wherein the noise added to the selected gradient to generate the noised gradient includes an isotropic Gaussian noise.

10. The method of claim 9, wherein the privacy function is defined according to the following Equation:
$${α}^{- 1} \leq \frac{p ( {\tilde{g}}_{s} - {g}_{s} )}{p ( {\tilde{g}}_{s} - {g}_{i} )} \leq α$$
where α=exp(γ) for some γ>0, p(·) denotes the density of the isotropic Gaussian noise [symbol] (0, Iσ²), gₛ is the selected gradient, \tilde{g}ₛ is the noised gradient, and gᵢ is a gradient of the plurality of gradients.

11. The method of claim 8, wherein the privacy function is defined according to the following Equation:
$$\vert ln p ( z ) - ln p ( {\tilde{g}}_{s} - {g}_{i} ) \vert \leq γ$$
where γ>0, p(·) denotes the density of the noise z, \tilde{g}ₛ is the noised gradient, and gr is a gradient of the plurality of gradients.

12. The method of claim 8, wherein the gradient of the plurality of gradients is randomly selected.

13. The method of claim 8, wherein the data samples are associated with transactions in an electronic payment processing network, and wherein the method further comprises:
providing, with the at least one processor, the trained machine learning model;
receiving, with the at least one processor transaction data associated with the transaction currently being processed in the electronic payment processing network;
processing, with the at least one processor, using the trained machine learning model, the transaction data to generate a prediction associated with the transaction; and
authorizing or denying, with the at least one processor, based on the prediction, the transaction in the electronic payment processing network.

14. The method of claim 13, wherein the prediction includes a classification of the transaction as a fraudulent transaction or a non-fraudulent transaction.

15. A computer program product, comprising:
at least one non-transitory computer-readable medium including program instructions that, when executed by at least one processor, cause the at least one processor to:
(i) obtain a dataset including a plurality of batches of data samples;
(ii) compute a plurality of gradients of the plurality of batches of data samples;
(iii) select a gradient of the plurality of gradients;
(iv) add noise to the selected gradient to generate a noised gradient;
(v) determine, based on the noised gradient and the plurality of gradients, a number of gradients of the plurality of gradients that satisfy a privacy function;
(vi) in response to the number of gradients of the plurality of gradients that satisfy the privacy function satisfying a threshold number, train, using the noised gradient, a machine learning model; and
(vii) in response to the number of gradients of the plurality of gradients that satisfy the privacy function failing to satisfy the threshold number, reshuffle the dataset to generate an updated plurality of batches of data samples and returning to step (ii).

16. The computer program product of claim 15, wherein the noise added to the selected gradient to generate the noised gradient includes an isotropic Gaussian noise.

17. The computer program product of claim 16, wherein the privacy function is defined according to the following Equation:
$${α}^{- 1} \leq \frac{p ( {\tilde{g}}_{s} - {g}_{s} )}{p ( {\tilde{g}}_{s} - {g}_{i} )} \leq α$$
where α=exp(γ) for some γ>0, p(·) denotes the density of the isotropic Gaussian noise [symbol] (0, Iσ²), gₛ is the selected gradient, \tilde{g}ₛ is the noised gradient, and gᵢ is a gradient of the plurality of gradients.

18. The computer program product of claim 15, wherein the privacy function is defined according to the following Equation:
$$\vert ln p ( z ) - ln p ( {\tilde{g}}_{s} - {g}_{i} ) \vert \leq γ$$
where γ>0, p(·) denotes the density of the noise z, \tilde{g}ₛ is the noised gradient, and gᵢ is a gradient of the plurality of gradients.

19. The computer program product of claim 15, wherein the gradient of the plurality of gradients is randomly selected.

20. The computer program product of claim 15, wherein the data samples are associated with transactions in an electronic payment processing network, and wherein the at least one processor is further configured to:
provide the trained machine learning model;
receive transaction data associated with the transaction currently being processed in the electronic payment processing network;
process, using the trained machine learning model, the transaction data to generate a prediction associated with the transaction; and
authorize or deny, based on the prediction, the transaction in the electronic payment processing network, and
wherein the prediction includes a classification of the transaction as a fraudulent transaction or a non-fraudulent transaction.
